(19) United States
(12) Patent Application Publication
(10) Pub. No.: US 2021/0024100 A1
(43) Pub. Date: Jan. 28, 2021

(54) HYBRID HUMAN/AV DRIVER SYSTEM

(71) Applicant: UATC, LLC, San Francisco, CA (US)

(72) Inventors: Mark Calleija, San Mateo, CA (US); Pezhman Zarifian, Walnut Creek, CA (US); Eric Chen Deng, San Francisco, CA (US); Juan Argote Cabanero, Pittsburgh, PA (US); Erin Deniz Yaylali, San Francisco, CA (US)

(21) Appl. No.: 16/947,246

(22) Filed: Jul. 24, 2020

Related U.S. Application Data
(60) Provisional application No. 62/879,282, filed on Jul. 26, 2019.

(51) Int. Cl. B60W 60/00; G08G 1/00

(52) U.S. Cl. CPC B60W 60/0053; B60W 60/00253; B60W 2554/408; B60W 2552/05; B60W 2554/406; G08G 1/202

(57) ABSTRACT

A vehicle routing system instructs a first vehicle having a human driver to execute a first route for delivering a first payload from a first pick-up location to a first destination. Instructions provided to the first vehicle include an instruction to drop-off the human driver at a driver transfer location along the first route and to continue along the first route without the human driver. The system further instructs a second vehicle that is operating autonomously to execute a second route that also includes the driver transfer location. The instructions to the second vehicle include an instruction to pick-up the human driver from the first vehicle at the driver transfer location and to continue along the second route with the human driver. The route segments may be labeled as suitable or unsuitable for autonomous driving to identify where to locate the driver transfer locations.

### CLAIM FOR PRIORITY

This application claims the benefit of priority of U.S. Provisional Application No. 62/879,282, filed Jul. 26, 2019, which is hereby incorporated by reference in its entirety.

### TECHNICAL FIELD

The disclosure herein is directed to devices, systems, and methods for providing a “hybrid driver” system where an autonomous vehicle (AV) conducts part of a trip under the control of an AV stack and another part of the trip is conducted by a human driver, where the human driver is passed between more than one AV.

### BACKGROUND

Primarily due to technological limitations and safety/ethical requirements for autonomous vehicle (AV) technology, the wide-spread adoption of self-driving vehicles is expected to take time. Next steps in the evolution to purely self-driving vehicles include hybrid robot/human driven vehicles for trips using transport services such as Uber and Lyft. For example, U.S. patent application Ser. No. 15/450,268, filed Mar. 6, 2017, entitled “Hybrid Trip Planning for Autonomous Vehicles” describes a system that provides a balance between human-driven and manual control of an AV and autonomous control of the AV throughout a given region. The hybrid system is designed to use the autonomous control of the AV in areas where an autonomy grid map is available and a human driver where the autonomy grid map is not available. However, the safety driver is required to be present in the vehicle at all times.

As a further transition to purely self-driving vehicles, it is desired to reduce, and eventually to remove the requirement of the safety driver. In this scenario, the human driver would drive on route segments appropriate for a human driver, and the AV would drive the route segments where the vehicle is capable of performing autonomous driving tasks. This approach presents logistical issues for moving the human driver from AV to AV without disrupting the rider's experience. Such logistical issues are addressed herein.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a block diagram illustrating an example trip planning system, according to examples described herein.

FIG. 2 is a block diagram illustrating an example autonomous vehicle in communication with a trip planning system, as described herein.

FIGS. 3A-3C are diagrams that collectively illustrate a driver drop-off by a first AV and pick-up by a second AV in a sample embodiment.

FIG. 4A is a diagram that illustrates a driver transfer location that is a safe pull off location on the side of a public street.

FIG. 4B is a diagram that illustrates a driver transfer location that is a dedicated interchange point such as a dedicated portion of a parking lot.

FIG. 4C is a diagram that illustrates a driver transfer location that is a dedicated interchange point that is owned and/or operated by the operator of the fleet of AVs.

FIG. 4D is a diagram that illustrates a driver transfer location that is a dedicated interchange point located in a median strip of the highway and that is owned and/or operated by the operator of the fleet of AVs.

FIGS. 5A and 5B illustrate example user interfaces providing mode transition prompts for a human driver of an autonomous vehicle.

FIG. 6 is a flow chart describing an example method of trip planning for autonomous vehicles, according to examples described herein.

FIG. 7 is flow chart describing another example method of trip planning for autonomous vehicles, according to examples described herein.

FIG. 8 is a flow chart of a method for routing two autonomous vehicles that share one human driver in sample embodiments.

FIG. 9 is a flow chart of another method for routing two autonomous vehicles that share one human driver in sample embodiments.

FIG. 10 is a block diagram showing one example of a software architecture for a computing device in sample embodiments.

FIG. 11 is a block diagram illustrating a computing device hardware architecture within which a set or sequence of instruction may be executed to cause a machine to perform examples of any one of the methodologies discussed in sample embodiments.

### DESCRIPTION

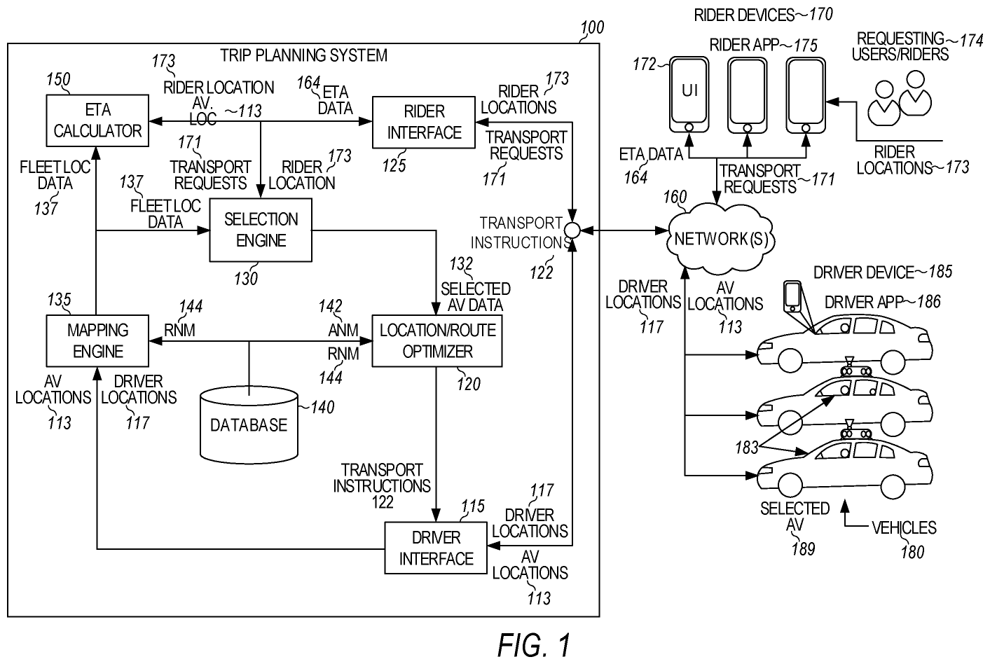

It should be understood at the outset that although an illustrative implementation of one or more embodiments are provided below, the disclosed systems and/or methods described with respect to FIGS. 1-11 may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As described herein, an autonomous vehicle is a vehicle that is capable of sensing its environment and operating some or all of the vehicle's controls based on the sensed environment. An autonomous vehicle includes sensors that capture signals describing the environment surrounding the vehicle. The autonomous vehicle processes the captured sensor signals to comprehend the environment and automatically operates some or all of the vehicle's controls based on the resulting information. In an autonomous or semi-autonomous vehicle, an autonomous vehicle (AV) control system controls one or more of the braking, steering, or throttle of the vehicle. In a fully-autonomous vehicle, the AV control system assumes full control of the vehicle. In a semi-autonomous vehicle, the AV control system assumes a portion of the vehicle control, with a human user (e.g., a vehicle operator) still providing some control input.

In order to navigate its surrounding environment, an autonomous vehicle (AV) may include a perception sensor system generating sensor data used to build a sensor view of the environment. The perception sensor system may include any number of cameras (e.g., stereoscopic or monocular cameras), LiDAR sensors, SONAR sensors, infrared sensors, RADAR, inertial measurement units (IMU), encoders (e.g., wheel speed encoders), and/or other types of proximity or imaging sensors. The control system may comprise one or more processors executing an instruction set that causes the control system to process a sensor view generated by the perception sensor system to perform object detection operations and autonomously operate the vehicle's acceleration, braking, and steering systems. In addition, the sensor data generated from the various AV sensors may be logged and uploaded to an AV management system.

Consider the example scenario where a customer orders a transportation service such as Uber, Lyft, Curb, DidiChuxing, Grab, Ola, etc., and gets picked-up in the middle of the city by a vehicle for a 20-mile ride to the airport. The transport service backend system optimizes what parts of the ride should be human driven versus robot (self) driven and plans a route so that the human driver gets out of the car at a driver transfer location so that the AV may complete the trip to the airport over self-driving compatible route segments without the human driver. The customer may or may not get out of the vehicle during their trip. The driver's entry into or exit from the vehicle at the driver transfer location takes place quickly and seamlessly and is smooth for the customer. For example, the customer could be asleep from the pick-up point in the city to the drop-off point at the airport.

In sample implementations, the human drivers would operate the parts of the trip where the robot driver is incapable of reliably self-driving, while the robot driver would operate the AV for the portions of the ride appropriate for reliable self-driving. In sample embodiments, a geographic area may be described by a routing graph where a human driver is chosen to carry out the driving tasks for some portions and a robot driver is chosen for other portions. The suitability of a human driver versus a robot driver may be encoded into the existing routing graph by, for example, providing a property for a route segment indicating that the route segment is or is not suitable for AV operation. Also, the self-driving vehicle (SDV) platform may support different vehicles from different manufacturers having different capabilities. A route segment that is unsuitable for autonomous operation by one manufacturer's AV may be suitable for autonomous operation by another manufacturer's AV. Such differences may be accounted for through use of the properties assigned to the route segment. The transport service backend system may automatically assign each manufacturer's AVs to specific geographic areas based on the needs of each trip and the self-driving capabilities of the AV.

The logistics of coordinating the switching from human driver to robot driver and vice-versa and for managing the pick-up and drop-off of the human drivers in such a system is addressed herein.

In sample embodiments, a system is described that routes vehicles by instructing a first vehicle having a human driver to execute a first route for delivering a first payload (human or package) from a first pick-up location to a first destination where the first route includes a driver transfer location. Instructing the first vehicle also includes providing an instruction to the first vehicle to drop-off the human driver at the driver transfer location and to continue along the first route autonomously. The system further instructs a second vehicle (that may be robot-driven) to execute a second route that also includes the driver transfer location. Instructions are further provided to the second vehicle that instruct the second vehicle to pick-up the human driver from the first vehicle at the driver transfer location and to continue along the second route with the human driver operating the second vehicle manually. In sample embodiments, route segments of the first route after the driver transfer location are labeled as suitable for autonomous driving, while the route segments of the second route after the driver transfer location are labeled as unsuitable for autonomous driving. In further sample embodiments, the first vehicle executes the first route for a first transportation service and the second vehicle executes the second route for a second transportation service. In this example, the vehicles for the respective services may operate in autonomy mode on routing graphs for their respective transport services.

In further sample embodiments, the system causes first mapping and routing information to be generated on an interior user interface of the first vehicle. The first mapping and routing information provides the human driver with an optimal route from the first pick-up location to the driver transfer location. Similarly, the system further causes second mapping and routing information to be generated on an interior user interface of the second vehicle. The second mapping and routing information provides a human driver with an optimal route from the driver transfer location to a destination of the second route.

In further sample embodiments, the first route comprises a second driver transfer location and the first vehicle is instructed to pick-up a second human driver at the second driver transfer location and to continue along the first route with the second human driver toward the first destination to deliver the first payload. The first route including the driver transfer location and the second driver transfer location may be determined based on distance optimizations using a road network map and/or based on time optimizations using a live traffic map. An optimization may be performed to determine an autonomy route for the first vehicle along route segments from the driver transfer location to the second driver transfer location and to transmit route data to the first vehicle. The route data is executable by a control system of the first vehicle to indicate an optimized autonomy route from the first driver transfer location to the second driver transfer location.

In further sample embodiments, a first transport request is received for delivering the first payload from the first pick-up location to the first destination. In response, the system selects the first vehicle to service the first transport request based on the first pick-up location and the first destination identified in the first transport request. This selection fulfills a set of criteria including a distance threshold, time threshold, and/or a driver wait time threshold. The distance threshold comprises a minimum distance percentage in which the first vehicle may be in an autonomous mode between the first pick-up location and the first destination or a maximum distance percentage in which the first vehicle may be in a manual mode between the first pick-up location and the first destination. The time threshold comprises a minimum time percentage in which the first vehicle may be in the autonomous mode between the first pick-up location and the first destination or a maximum time percentage in which the first vehicle may be in the manual mode between the first pick-up location and the first destination. The driver wait time threshold comprises a maximum time that the second vehicle will wait for the human driver to arrive at the driver transfer location via the first vehicle, exit the first vehicle, and enter the second vehicle. The first transport request may also include preferences from a first requesting user between minimizing at least one of time and cost for a trip from the first pick-up location to the first destination. Such preferences may include whether the first requesting user would prefer to spend more to arrive in less time with only the human driver or spend less to arrive in more time. The latter preference may include at least part of the trip from the first pick-up location to the first destination being driven in autonomous mode without a human driver. This time-cost trade assumes that the autonomous mode is constrained by a lower speed limit due to the limited capability of the AV.

In further sample embodiments, the driver transfer location comprises a pull off location on a side of a public street or anywhere along the side of a particular roadway adjacent a route segment that is suitable for autonomous driving. The driver transfer location also may comprise a dedicated interchange point adjacent a route segment that is suitable for autonomous driving or a dedicated interchange point located in a median strip or on a side of the roadway of a route segment that is suitable for autonomous driving. In such embodiments, a pod or other place for the human to wait (e.g., in a building) may be provided at the driver transfer location to provide a place for the human driver to wait after exiting the first vehicle until arrival of the second vehicle.

In further sample embodiments, the first route and the second route are determined by taking into account supply/demand and likelihood or distribution of delay versus time for the human driver and the first payload. The first route and the second route may also be determined by taking into account an expected arrival time of the human driver at the driver transfer location and an expected arrival time of the second vehicle at the driver transfer location to minimize a wait time of the human driver while also generally optimizing for a zero wait time for the rider (i.e. so there is always a human driver ready for the rider/payload). Generally, the system would never prioritize minimizing the wait time of the driver over minimizing the trip time for the rider.

In further sample embodiments, the system provides safety features for the riders and drivers. For example, an authentication system may be provided to pre-authenticate the human driver to drive the second vehicle before the human driver is enabled to enter the second vehicle. The authentication system may further provide the human driver's vehicle cabin preferences, including seat, steering wheel, and/or mirror adjustments to the second vehicle so that the driver's cabin preferences for the second vehicle may be pre-adjusted when the human driver enters the second vehicle, thereby speeding up the driver's entry into the vehicle and allowing for a speedier departure. The authentication system may further provide identification information to the second vehicle that authenticates the human driver when the human driver approaches the second vehicle so that a door of the second vehicle automatically unlocks based on proximity of the second vehicle to the human driver at the driver transfer location. Such an authentication system may include an RFID system and/or a BlueTooth™ system that communicates the identification information between the human driver and the second vehicle. The authentication system may further include a facial recognition system, an iris scanning system, a fingerprinting system, and/or a voice recognition system to authenticate the human driver.

In further sample embodiments, the first vehicle, the second vehicle, and/or the driver transfer location may include sensors that detect the presence or exiting of the human driver from the first vehicle or the presence or entrance of the human driver into the second vehicle. The first vehicle may also include a stopped vehicle detection system that prohibits the human driver from exiting the first vehicle unless the first vehicle is completely stopped and a parking brake is engaged. Also, the first vehicle may include a first audio/visual display that notifies a user/rider that the human driver is about to exit the first vehicle. Similarly, the second vehicle may include a second audio/visual display that notifies the user/rider that the human driver is about to enter the second vehicle.

In further sample embodiments, the system may further determine transportation of the human driver between driver transfer locations by, for example, tracking the location of the user and providing routing instructions to the human driver. The sample embodiments described thus may further determine the logistics of transportation of the human driver between driver transfer locations.

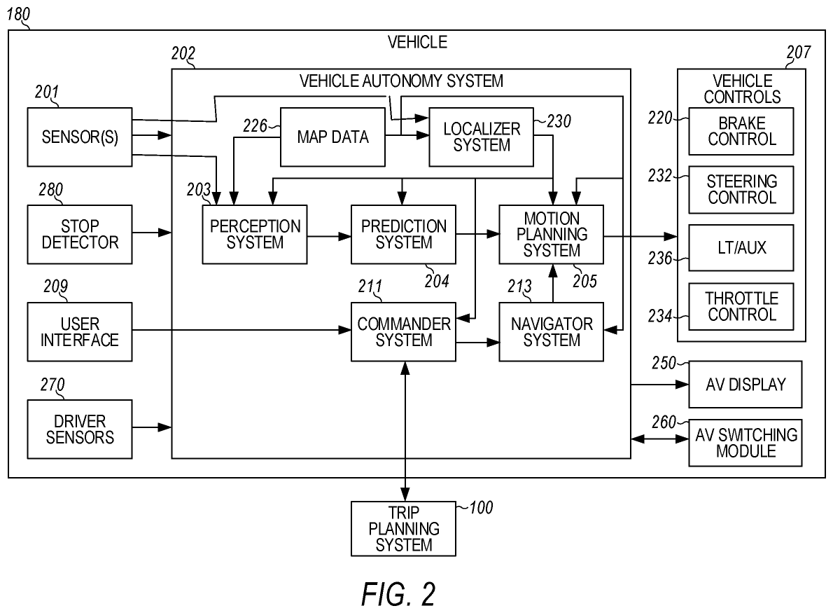

FIG. 1 is a block diagram illustrating autonomous vehicles in communication with an autonomous vehicle management system. In the sample embodiment of FIG. 1, the autonomous vehicle (AV) control system is a trip planning system 100 that routes an autonomous vehicle 180 through a geographic region for a variety of purposes, including transport services (e.g., on-demand transport, freight and delivery services, etc.) and also coordinates the switching from human driver to robot driver and vice-versa and for managing the pick-up and drop-off of the human drivers. In the examples described, when under control of the robot driver, an onboard AV stack (FIG. 2) autonomously steers, accelerates, shifts, brakes, and operates lighting or other components (e.g., horn wipers, suspension) of the vehicle based on the route and the sensed environment. The trip planning system 100 provides a balance between human-driven, manual control of an autonomous vehicle (AV), and autonomous control of the AV throughout a given region. In various implementations, the trip planning system 100 may receive transport requests from requesting users in connection with an on-demand transportation service. The trip planning system 100 may manage both human drivers as well as autonomous capable vehicles providing transportation services for requesting users of the on-demand transportation service. In doing so, the trip planning system 100 may select AVs 180 to service transport requests in accordance with the suitability of particular route segments to a human versus a robot driver and the capabilities of the AV to autonomously drive particular route segments. As such, the trip planning system 100 distinguishes between purely human driven vehicles and robot driven autonomous vehicles.

For each received transport request, the trip planning system 100 may determine a set of candidate vehicles that are within a predetermined proximity or time from a pick-up location identified in the transport request. Additionally, or alternatively, the trip planning system 100 may determine whether the transport request satisfies a set of criteria for the on-demand AV service. For transport requests in which the pick-up location and drop off location are in areas suitable for autonomous vehicles, the trip planning system 100 may instruct and AV 180 to operate in an autonomous mode to rendezvous with the requesting user at the pick-up location and to transport the requesting user to the drop off location without manual control by the human driver. For transport requests in which all viable routes between the pick-up location and drop off location include route segments that identified as more appropriate for human driving, the trip planning system 100 may invite a proximate human driver to rendezvous with the requesting user and service the transport request for at least those portions of the route for which the criteria suggests that a human driver would be appropriate. The invited human driver may also rendezvous with the requesting user via the network assets, i.e., other human or robot driven vehicles in the network.

As in the airport example above, certain transport requests involve pick-up locations and drop-off locations that have routes therebetween (e.g., most optimal routes in terms of distance and/or time). These transport requests allow for autonomous vehicle operation along portions of the route identified as suitable for autonomous operation, while manual operation is specified along portions of the route that satisfy the criteria for human driving. For example, the pick-up location indicated by the transport request may be in an area identified as appropriate for manual control of the AV to get to the pick-up location. Likewise, the drop off location may be in an area identified as appropriate for manual control of the AV. However, other route segments along the route may be identified as suitable for autonomous driving. As provided herein, such examples may comprise hybrid routes involving both manual and autonomous control modes of the AV.

For such hybrid trips, in determining a most optimal overall route from a pick-up location to drop off location, the trip planning system 100 may perform a set of optimizations to determine one or more optimal routes that may include route segments suitable for autonomous control, manual control, or either. This set of optimizations may be performed as at least one of distance optimizations, time optimizations, risk optimizations, overall cost optimizations, fuel or power consumption optimizations, or any combination of the foregoing.

Accordingly, for certain transport requests, the trip planning system 100 may select an AV 180 to fulfill the request by selecting the AV 180 from a plurality of candidate AVs. If the pick-up location is in an area identified as more appropriate for human driving, the trip planning system 100 may identify an AV with a human driver to fulfill the request. However, if the drop off location is an area identified as suitable for autonomous driving, an AV with a robot driver may fulfill the request. As will be explained below, the human driver may be dropped off at a driver transfer location for pick-up by another AV 180 in need of a human driver to navigate the other AV 180 over portions of the map more appropriate for human driving. From there, the AV 180 that dropped off its human driver may switch from the manual mode to the autonomous mode and complete the portion of the trip that includes route segments identified as suitable for autonomous driving. For example, upon leaving the AV 180, the human driver may actively switch the AV 180 to autonomous mode via an input mechanism within the interior of the AV 180, or the AV 180 may automatically engage in the autonomous mode when the driver exits based on sensor information on the AV or through teleoperation (e.g., via a remote station control operator).

Upon entry into the vehicle, the human driver may switch the AV from the autonomous mode to the manual mode to enable the human driver to continue the trip. The transport data may be executable by the AV 180 to cause mapping and routing information to be generated on an interior user interface of the AV 180. The mapping and routing information may provide the human driver with the optimal route from the pick-up location (or the driver transfer location where the human driver entered the AV) to the drop off location.

In certain implementations, the human driver may diverge from the given routes along the optimal route. In such examples, diverging from the given route may trigger the trip planning system 100 to perform additional optimizations to update the optimal route. Thereafter, the trip planning system 100 may transmit updated transport instructions to the AV 180 indicating the updated routes. Also, as will be apparent from the following, such route changes may cause the human driver to be dropped off at a different driver transfer location, which will necessitate an update to the algorithm matching the human driver to another AV 180. This could in turn affect the pick-up/drop-off estimated time of arrival (ETA) and optimization of subsequent near-term trip(s) assigned to the second AV 180.

The trip planning system 100 may set or otherwise establish each of the driver transfer locations appropriate for the human driver. This may facilitate safe and even seamless transitions between the manual mode and the autonomy mode for fast, efficient drop offs of the human driver and vice-versa. Furthermore, it is contemplated that one or more processes described herein with respect to the trip planning system 100 may be performed by the AV 180. For example, upon being selected to service a transport request, the AV 180 may be provided with a pick-up location and destination and may store a routing graph on-board. The AV 180 may then perform the route optimizations (e.g., based on the overall route between the pick-up location and destination, or segmented into multiple optimized routes), and may generate indications or prompts on an on-board display for the human driver to manually operate the AV 180 in areas appropriate for human driving, and to prepare to exit the AV 180 at driver transfer locations so that the AV 180 may complete the route over route segments that are appropriate for autonomous driving without the human driver.

Among other benefits, the examples described herein achieve a technical effect of facilitating the transition from AVs operating on current, limited autonomy grid maps to the eventual fully mapped cities and regions in which manual operation is no longer needed. Because extensive time, labor, and monetary resources are currently required to fully map a given area, such hybrid planning and routing is beneficial in both testing and bolstering the robustness of AV systems. Accordingly, the road networks of metropolitan areas may be analyzed to determine the most efficient or effective autonomy plan, and hybrid routing may be leveraged until the entire road network is fully mapped for autonomous capabilities.

As used herein, a computing device refers to devices corresponding to desktop computers, cellular devices or smartphones, personal digital assistants (PDAs), laptop computers, tablet devices, virtual reality (VR) and/or augmented reality (AR) devices, wearable computing devices, television (IP Television), etc., that may provide network connectivity and processing resources for communicating with the system over a network. A computing device may also correspond to custom hardware, in-vehicle devices, or on-board computers, etc. The computing device may also operate a designated application configured to communicate with the network service.

As illustrated in FIG. 1, trip planning system 100 may communicate, over one or more networks 160, with requesting users or riders 174 throughout a given region where on-demand transportation services are provided. Specifically, each requesting user 174 may execute a rider application 175 on the user's/rider's computing device 170. As provided herein, the user's/rider's computing device 170 may comprise a mobile computing device, personal computer, tablet computing device, virtual reality (VR) or augmented reality (AR) headset, and the like. Execution of the rider application 175 may cause the user's/rider's computing device 170 to establish a connection over the one or more networks 160 with a rider interface 125 of the trip planning system 100.

In various aspects, the executing rider application 175 may cause a user interface 172 to be generated on a display screen of the user's/rider's computing device 170. Using the user interface 172, the requesting user/rider 174 may generate and transmit a transport request 171 to the rider interface 125. In various examples, the trip planning system 100 may further include a selection engine 130 that ultimately selects an AV 189 to service the transport request 171.

According to examples, the trip planning system 100 may include a driver interface 115 that connects, via the one or more networks 160, with a fleet of AVs 180 available to provide on-demand transportation services to the requesting users/riders 174. In various examples, the AVs 180 may comprise a fleet of AVs and any number of drivers 183 servicing a given region. As provided herein, the given region may include a partial autonomy mapped road network on which AVs may operate with a robot driver while the entirety of the given region may be serviced by the AVs with human drivers 183. The trip planning system 100 may include a database 140 storing routing graphs detailing the entirety of the given region in which on-demand transport services are available. As noted above, different route segments within the routing graphs may include properties indicating that the route segment is appropriate for human driving and/or autonomous driving without human control or intervention.

In certain aspects, the human drivers 183 may also operate the AVs to provide transportation services at will, where the human driver may execute a driver application 186 on a driver device 185 (e.g., a mobile computing device, smart phone, tablet computing device, etc.), causing the driver device 185 to transmit location data indicating the driver's location 117 to the driver interface 115. The executing driver application 186 also may enable the human driver 183 to receive transport instructions (TIs) 122 indicating a pick-up location to rendezvous with a matched requesting user 174 to service a given transport or product pickup/delivery request 171.

Likewise, a selected AV 189 in the fleet may transmit its AV location 113 to the driver interface 115 of the trip planning system 100. In many examples, the trip planning system 100 may also include a mapping engine 135, which may receive the AV locations 113 to provide overall fleet location data 137 to a selection engine 130. The fleet location data 137 may include the dynamic locations of each AV 180, whether human driven or robot driven, of the available AVs 180 throughout the given region. The mapping engine 135 may provide the fleet location data 137 to enable the selection engine 130 to match available AVs 180, with or without a human driver, with requesting users/riders 174.

The selection engine 130 may receive the transport requests 171 from the rider interface 125. The transport requests 171 may include respective pick-up locations of the requesting users/riders 174. The selection engine 130 may also receive user/rider locations 173 (e.g., from location-based resources, such as GPS or other sensor-based localization data) from the user's/rider's computing device 170 through the rider interface 125. Utilizing the pick-up location and/or the user/rider location 173 for a given transport request 171, the selection engine 130 may identify a set of candidate AVs 180 to service the transport request 171. In doing so, the selection engine 130 may identify vehicles proximate to the pick-up location indicated in the transport request 171 or the rider location 173 and determine the set of candidate AVs based on the vehicles being a predetermined distance or time from the pick-up location or user/rider location 173.

The trip planning system 100 may include ETA calculator 150, which may receive the fleet location data 137 from the mapping engine 135. The ETA calculator 150 may utilize the fleet location data 137 and user/rider location 173 to provide ETA data 164 to the rider computing device 170 over the one or more networks 160. In doing so, the mapping engine 135 may generate live traffic data along with the fleet location data 137 to estimate an arrival time for a designated vehicle (e.g., a closest available vehicle or AV) to the user/rider location 173. Furthermore, once an AV 180 is selected to service a given transport request 171, the selection engine 130 may provide the selected AV's location 113 to the ETA calculator 150. The ETA calculator 150 may then filter out all other vehicles in order to provide ETA data 164 of the selected vehicle to the rider's computing device 170.

According to examples described herein, the selection engine 130 may select AVs 180 according to a set of criteria. If this set of criteria is met for a given AV 180 and transport request 171, then the selection engine 130 may select the AV 189 to service the transport request 171. In some examples, the set of criteria may include data specifying whether a minimum portion of the overall trip may be driven by the selected AV 189 in autonomy mode with a robot driver. In other words, if the minimum threshold for a portion of the trip that may be driven in autonomy mode by the robot driver is not met, then the trip may be conducted entirely in manual mode by the human driver. The minimum portion may comprise a minimum distance percentage of the trip (e.g., 70% distance must be in autonomy mode or some minimum absolute distance value, e.g., 10 miles), a minimum estimated time percentage of the trip (e.g., 70% of estimated time must be in autonomy mode or some minimum absolute time value, e.g., 20 minutes), and/or a maximum threshold for extra driving in manual mode (e.g., 15% of distance or estimated time). Other criteria may also be used to set a minimum percentage of the trip for autonomy mode. Satisfaction of the set of criteria may be determined based on the most optimal route between the pick-up location and the drop off location, including any driver transfer locations, or from the current location of the selected AV 189 to the drop-off location (including making the pick-up).

In certain implementations, the trip planning system 100 may route the selected AV 189 through route segments appropriate for autonomous driving if doing so would be the most optimal in terms of distance and/or time. To ensure that the user/rider is not unduly delayed, the set of criteria may include a maximum extra driving threshold, which may ensure that the selected AV 189 does not diverge from the actual optimal path by more than a threshold distance or estimated time to account for drop-off of the driver. In one example, this threshold may correspond to 15% extra distance or time in comparison to the actual optimal path (e.g., a shortest path from the pick-up location and drop-off location). Accordingly, only when the threshold is not exceeded does the selection engine 130 select a hybrid trip as described herein. When the threshold is exceeded, the selected AV 189 may be routed so that the entire trip may be completed by the human driver.

Thus, upon selecting AV 189 to service a given transport request 171, the selection engine 130 may provide AV data 132 corresponding to the selected AV 189 to a location/route optimizer 120 of the trip planning system 100. When calculating the optimal route, the location/route optimizer 120 may analyze the selected AV data 132 in the context of the routing graph to determine a most optimal route from the pick-up location indicated in the transport request 171 to the destination or drop-off point indicated in the transport request 171. In determining the most optimal entry point, the location/route optimizer may determine a plurality of possible routes from the pick-up location and converge on the most optimal route by performing a distance or time optimization from the pick-up location to the drop off location. The location/route optimizer 120 may first determine a most optimal overall route from the pick-up location to the drop off location.

In various examples, the location/route optimizer 120 may optimize the overall route between the pick-up location to drop off location or may segment the route into separate optimizations for manual and autonomous route segments. For example, location/route optimizer 120 may perform an initial route optimization between the pick-up location and the destination. Additionally, the location/route optimizer 120 may perform a route optimization for the trip assuming that route segments suitable for autonomous driving are driven in autonomy mode.

In segmenting the overall route in the above manner, location/route optimizer 120 may generate and provide the selected AV 189 with a set of transport instructions 122 indicating each of the route segments. The transport instructions 122 may be executable by the AV computation module of the AV 189 to provide route instructions on an interior display for the human driver 183 to first manually operate the AV 189 to the pick-up location and then to a driver transfer location. Thereafter, the executing transport instructions 122 may cause an indication to be displayed instructing the human driver 183 to exit the selected AV 189 at the driver transfer location and to switch the AV 189 into autonomy mode (in cases where the AV does not automatically switch to autonomy mode). The AV stack of the AV 189 autonomously operates the AV 189 along the route segments suitable for autonomous driving along the identified optimal route. Thereafter, the executing transport instructions 122 may cause the AV 189 to pull into a driver transfer location to pick-up a human driver who may drive the selected AV 189 along additional route segments that are more appropriate for human driving. The human driver 183 may then manually operate the AV 189 in accordance with the displayed route information on driver device 185 to the drop off location.

In sample embodiments, there may be a limit on how many human versus robot driver changes a trip may include. As an example, if the end-to-end route includes three segments suitable for a human driver and four segments suitable for a robot driver, the trip planning system may execute this plan or may choose to handle the entire trip with a human driver recognizing that it may be frustrating for the rider to stop at too many driver transfer locations and to switch between human and robot drivers multiple times.

In generating the transport instructions 122, the location/route optimizer 120 may allow the selected AV 189 to utilize onboard route planning resources in order to determine its own path through the route segments suitable for autonomous driving. Furthermore, in determining the most optimal route, the location/route optimizer 120 may consider where driver transfer locations may be located along the route.

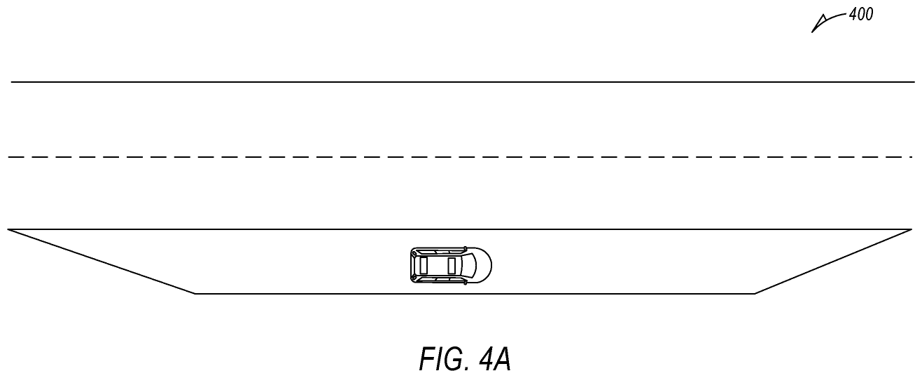

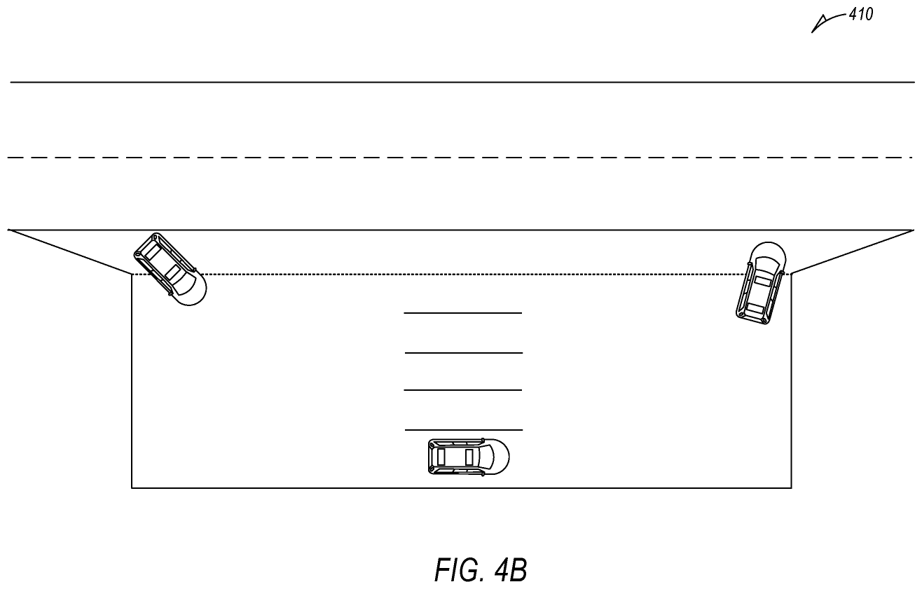

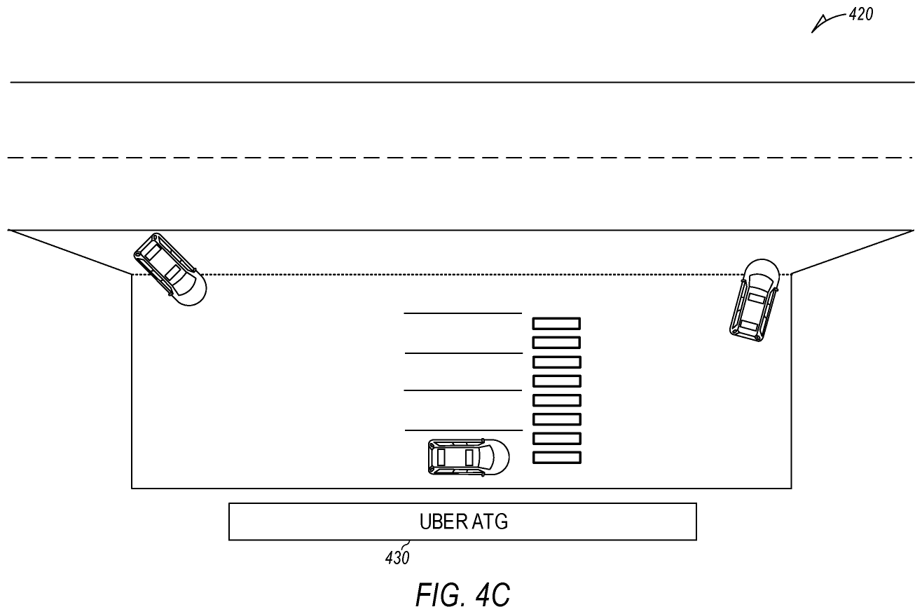

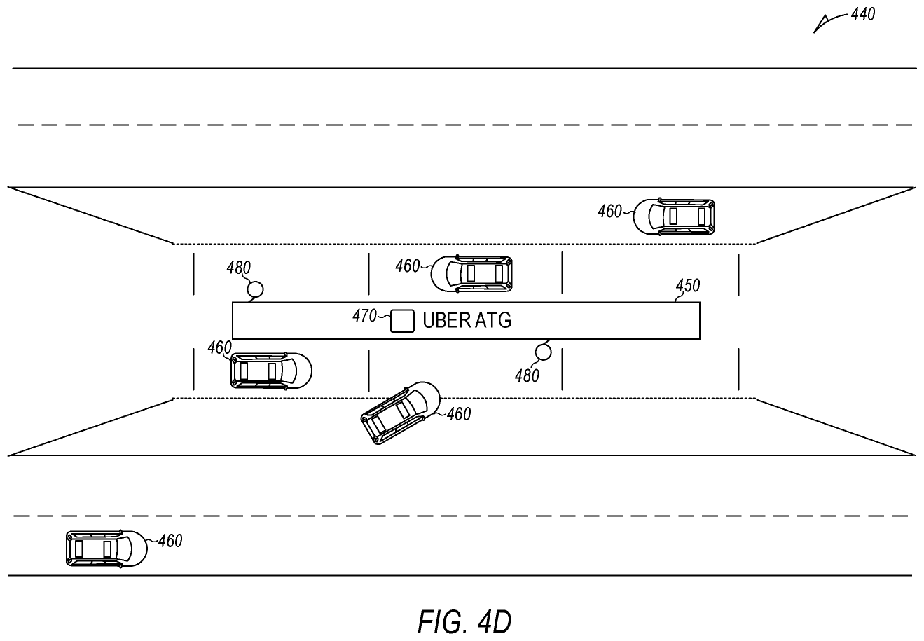

For example, the driver transfer locations may be located at public or private locations near entry and exit points to/from route segments identified as suitable for autonomous driving where the drivers may quickly and safely exit and enter the AV 189 to continue the trip with least delay for the rider and the seamlessness of transition. However, examples described herein recognize that the most suitable driver transfer locations may be located in the middle of a route segment, in a parking area, at a designated loading and unloading area, or other predetermined locations within the regular curb space available for parking, as described below with respect to FIG. 4.

As described herein, the trip planning system 100 may support human driven routes, fully autonomous routes, and hybrid routes in which the human driver 183 of a given AV 189 operates the AV 189 in manual mode along a portion of the overall route. The location/route optimizer 120 may generate the set of transport instructions 122 to provide the human driver 183 with granular route instructions as well as timing instructions for exiting the AV 189 at a driver transfer location to, for example, minimize the time that the human driver 183 would need to wait at the driver transfer location before another AV arrives to be driven by the human driver 183. It will be appreciated that the AV 189 may recognize when the human driver 183 has exited the vehicle and automatically switch to autonomy mode, or the human driver 183 may be required to switch the AV 189 into autonomy mode. Likewise, switching modes from autonomy mode to manual mode upon pick-up of a human driver may be performed automatically upon detection and authentication of the driver or may require the human driver to switch the AV 189 into manual mode.

FIG. 2 depicts a block diagram of an example autonomous vehicle (AV) 180 according to example aspects of the present disclosure. The vehicle 180 includes one or more sensors 201, a vehicle autonomy system 202, and one or more vehicle controls 207. The vehicle 180 is an autonomous vehicle, as described herein. The example vehicle 180 shows just one example arrangement of an autonomous vehicle. In some examples, autonomous vehicles of different types may have different components and/or arrangements.

The vehicle autonomy system 202 includes a commander system 211, a navigator system 213, a perception system 203, a prediction system 204, a motion planning system 205, and a localizer system 230 that cooperate to perceive the surrounding environment of the vehicle 180 and determine a motion plan for controlling the motion of the vehicle 180 accordingly. It will be appreciated that these systems may be independent or combined into a combined system architecture.

The vehicle autonomy system 202 is engaged to control the vehicle 180 or to assist in controlling the vehicle 180. In particular, the vehicle autonomy system 202 receives sensor data from the one or more sensors 201, attempts to comprehend the environment surrounding the vehicle 180 by performing various processing techniques on data collected by the sensors 201, and generates an appropriate route through the environment. The vehicle autonomy system 202 sends commands to control the one or more vehicle controls 207 to operate the vehicle 180 according to the route.

Various portions of the vehicle autonomy system 202 receive sensor data from the one or more sensors 201. For example, the sensors 201 may include remote-detection sensors as well as motion sensors such as an inertial measurement unit (IMU), one or more encoders, or one or more odometers. The sensor data includes information that describes the location of objects within the surrounding environment of the vehicle 180, information that describes the motion of the vehicle 180, etc.

The sensors 201 may also include one or more remote-detection sensors or sensor systems, such as a LiDAR, a RADAR, one or more cameras, etc. As one example, a LiDAR system of the one or more sensors 201 generates sensor data (e.g., remote-detection sensor data) that includes the location (e.g., in three-dimensional space relative to the LiDAR system) of a number of points that correspond to objects that have reflected a ranging laser. For example, the LiDAR system measures distances by measuring the Time of Flight (TOF) that it takes a short laser pulse to travel from the sensor to an object and back, calculating the distance from the known speed of light.

As another example, a RADAR system of the one or more sensors 201 generates sensor data (e.g., remote-detection sensor data) that includes the location (e.g., in three-dimensional space relative to the RADAR system's frame of reference) of a number of points that correspond to objects that have reflected ranging radio waves. For example, radio waves (e.g., pulsed or continuous) transmitted by the RADAR system reflect off an object and return to a receiver of the RADAR system, giving information about the object's location, speed, and composition.

As yet another example, one or more cameras of the one or more sensors 201 may generate sensor data (e.g., remote sensor data) including still or moving images. Various processing techniques (e.g., range imaging techniques such as structure from motion, structured light, stereo triangulation, and/or other techniques) may be performed to identify the location (e.g., in three-dimensional space relative to the one or more cameras' frame of reference) of a number of points that correspond to objects that are depicted in an image or images captured by the one or more cameras. Other sensor systems may identify the location of points that correspond to objects as well.

As another example, the one or more sensors 201 may include a positioning system. The positioning system determines a current position of the vehicle 180. The positioning system may be any device or circuitry for analyzing the position of the vehicle 180. For example, the positioning system may determine a position by using one or more of inertial sensors, a satellite positioning system such as a Global Positioning System (GPS), based on IP address, by using triangulation and/or proximity to network access points or other network components (e.g., cellular towers, Wi-Fi access points, Bluetooth Low Energy beacons) and/or other suitable techniques. The position of the vehicle 180 may be used by various systems of the vehicle autonomy system 202.

Thus, the one or more sensors 201 are used to collect sensor data that, after a series of coordinate transformations, describes the location (e.g., in three-dimensional space relative to the vehicle 180's frame of reference) of points that correspond to objects within the surrounding environment of the vehicle 180. In some implementations, the sensors 201 may be positioned at various different locations on the vehicle 180. As an example, in some implementations, one or more cameras and/or LiDAR sensors may be located in a pod or other structure that is mounted on a roof of the vehicle 180 while one or more RADAR sensors may be located in or behind the front and/or rear bumper(s) or body panel(s) of the vehicle 180. As another example, camera(s) may be located in a pod or other structure that is mounted on a roof of the vehicle, or at the front or rear bumper(s) of the vehicle 180. Other locations may be used as well.

The localizer system 230 receives some or all of the sensor data from sensors 201 and generates vehicle poses for the vehicle 180. A vehicle pose describes a position, velocity, and attitude of the vehicle 180. The vehicle pose (or portions thereof) may be used by various other components of the vehicle autonomy system 202 including, for example, the perception system 203, the prediction system 204, the motion planning system 205 and the navigator system 213.

The absolute position of the vehicle 180 is a point in a three-dimensional space. In some examples, the position is described by values for a set of Cartesian coordinates, although any other suitable coordinate system may be used. The velocity of the vehicle 180 is a vector in a three-dimensional space. The magnitude of this vector provides the speed of the vehicle while the direction of the vector provides the attitude of the vehicle 180. The attitude of the vehicle 180 generally describes the way in which the vehicle 180 is oriented at its position. In some examples, attitude is described by a yaw about the vertical axis, a pitch about a first horizontal axis, and a roll about a second horizontal axis. In some examples, the localizer system 230 generates vehicle poses periodically (e.g., every second, every half second). The localizer system 230 appends time stamps to vehicle poses, where the time stamp for a pose indicates the point in time that is described by the pose. The localizer system 230 generates relative vehicle poses by comparing sensor data (e.g., remote sensor data) to map data 226 describing the surrounding environment of the vehicle 180.

In some examples, the localizer system 230 includes one or more pose estimators and a pose filter. Pose estimators generate pose estimates by comparing remote-sensor data (e.g., LiDAR, RADAR) to map data. The pose filter receives pose estimates from the one or more pose estimators as well as other sensor data such as, for example, motion sensor data from an IMU, encoder, or odometer. In some examples, the pose filter executes a Kalman filter algorithm or machine learning algorithm to combine pose estimates from the one or more pose estimators with motion sensor data to generate vehicle poses. In some examples, pose estimators generate pose estimates at a frequency less than the frequency at which the localizer system 230 generates vehicle poses. Accordingly, the pose filter generates some vehicle poses by extrapolating from a previous pose estimate utilizing motion sensor data.

Vehicle poses and/or vehicle positions generated by the localizer system 230 are provided to various other components of the vehicle autonomy system 202. For example, the commander system 211 may utilize a vehicle position to determine whether to respond to a call from the trip planning system 100.

The commander system 211 determines a set of one or more target locations that are used for routing the vehicle 180. The target locations are determined based on user input received via a user interface 209 of the vehicle 180 and/or from a request performed by the rider application 175 (FIG. 1). The user interface 209 may include and/or use any suitable input/output device or devices. In some examples, the commander system 211 determines the one or more target locations considering data received from the trip planning system 100. The trip planning system 100 is programmed to provide instructions to multiple vehicles, for example, as part of a fleet of vehicles for moving payloads (e.g., riders and/or cargo). Data from the trip planning system 100 may be provided via a wireless network, for example.

The navigator system 213 receives one or more target locations from the commander system 211 and map data 226. Map data 226, for example, provides detailed information about the surrounding environment of the vehicle 180. Map data 226 provides information regarding identity and location of different roadways and segments of roadways (e.g., lane segments or route segments). A roadway is a place where the vehicle 180 may drive and may include, for example, a road, a street, a highway, a lane, a parking lot, or a driveway. Routing graph data is a type of map data 226.

From the one or more target locations and the map data 226, the navigator system 213 generates route data describing a route for the vehicle to take to arrive at the one or more target locations. In some implementations, the navigator system 213 determines route data using one or more path planning algorithms based on costs for route segments, as described herein. For example, a cost for a route may indicate a time of travel, cost of travel, risk of danger, or other factors associated with adhering to a particular candidate route. For example, the reward may be of a sign opposite to that of cost. Route data describing a route is provided to the motion planning system 205, which commands the vehicle controls 207 to implement the route or route extension, as described herein. The navigator system 213 may generate routes as described herein using a general-purpose routing graph and constraint data. Also, in examples where route data is received from a dispatch system (instead of the navigator system 213), that route data may also be provided to the motion planning system 205.

The perception system 203 detects objects in the surrounding environment of the vehicle 180 based on sensor data, map data 226, and/or vehicle poses provided by the localizer system 230. For example, map data 226 used by the perception system describes roadways and segments thereof and may also describe: buildings or other items or objects (e.g., lampposts, crosswalks, curbing); location and directions of traffic lanes or lane segments (e.g., the location and direction of a parking lane, a turning lane, a bicycle lane, or other lanes within a particular roadway); traffic control data (e.g., the location and instructions of signage, traffic lights, or other traffic control devices); and/or any other map data that provides information that assists the vehicle autonomy system 202 in comprehending and perceiving its surrounding environment and its relationship thereto.

In some examples, the perception system 203 determines state data for one or more of the objects in the surrounding environment of the vehicle 180. State data describes a current state of an object (also referred to as features of the object). The state data for each object describes, for example, an estimate of the object's: current location (also referred to as position); current speed (also referred to as velocity); current acceleration; speed derivative values such as jerk; current heading; current orientation; size/shape/footprint (e.g., as represented by a bounding shape such as a bounding polygon or polyhedron); type/class (e.g., vehicle versus pedestrian versus bicycle versus other); yaw rate; distance from the vehicle 180; minimum path to interaction with the vehicle 180; minimum time duration to interaction with the vehicle 180; and/or other state information.

In some implementations, the perception system 203 determines state data for each object over a number of iterations. In particular, the perception system 203 updates the state data for each object at each iteration. Thus, the perception system 203 detects and tracks objects, such as other vehicles, that are proximate to the vehicle 180 over time.

The prediction system 204 is configured to predict one or more future positions for an object or objects in the environment surrounding the vehicle 180 (e.g., an object or objects detected by the perception system 203). The prediction system 204 generates prediction data associated with one or more of the objects detected by the perception system 203. In some examples, the prediction system 204 generates prediction data describing each of the respective objects detected by the prediction system 204.

Prediction data for an object is indicative of one or more predicted future locations of the object. For example, the prediction system 204 may predict where the object will be located within the next 5 seconds, 10 seconds, 100 seconds, etc. Prediction data for an object may indicate a predicted trajectory (e.g., predicted path) for the object within the surrounding environment of the vehicle 180. For example, the predicted trajectory (e.g., path) may indicate a path along which the respective object is predicted to travel over time (and/or the speed at which the object is predicted to travel along the predicted path). The prediction system 204 generates prediction data for an object, for example, based on state data generated by the perception system 203. In some examples, the prediction system 204 also considers one or more vehicle poses generated by the localizer system 230 and/or map data 226.

In some examples, the prediction system 204 uses state data indicative of an object type or classification to predict a trajectory for the object. As an example, the prediction system 204 may use state data provided by the perception system 203 to determine that a particular object (e.g., an object classified as a vehicle) approaching an intersection and maneuvering into a left-turn lane intends to turn left. In such a situation, the prediction system 204 predicts a trajectory (e.g., path) corresponding to a left-turn for the vehicle 180 such that the vehicle 180 turns left at the intersection. Similarly, the prediction system 204 determines predicted trajectories for other objects, such as bicycles, pedestrians, parked vehicles, etc. The prediction system 204 provides the predicted trajectories associated with the object(s) to the motion planning system 205.

In some implementations, the prediction system 204 is a goal-oriented prediction system 204 that generates one or more potential goals, selects one or more of the most likely potential goals, and develops one or more trajectories by which the object may achieve the one or more selected goals. For example, the prediction system 204 may include a scenario generation system that generates and/or scores the one or more goals for an object, and a scenario development system that determines the one or more trajectories by which the object may achieve the goals. In some implementations, the prediction system 204 may include a machine-learned goal-scoring model, a machine-learned trajectory development model, and/or other machine-learned models.

The motion planning system 205 commands the vehicle controls based at least in part on the predicted trajectories associated with the objects within the surrounding environment of the vehicle 180, the state data for the objects provided by the perception system 203, vehicle poses provided by the localizer system 230, map data 226, and route or route extension data provided by the navigator system 213. Stated differently, given information about the current locations of objects and/or predicted trajectories of objects within the surrounding environment of the vehicle 180, the motion planning system 205 determines control commands for the vehicle 180 that best navigate the vehicle 180 along the route or route extension relative to the objects at such locations and their predicted trajectories on acceptable roadways.

In some implementations, the motion planning system 205 may also evaluate one or more cost functions and/or one or more reward functions for each of one or more candidate control commands or sets of control commands for the vehicle 180. Thus, given information about the current locations and/or predicted future locations/trajectories of objects, the motion planning system 205 may determine a total cost (e.g., a sum of the cost(s) and/or reward(s) provided by the cost function(s) and/or reward function(s)) of adhering to a particular candidate control command or set of control commands. The motion planning system 205 may select or determine a control command or set of control commands for the vehicle 180 based at least in part on the cost function(s) and the reward function(s). For example, the motion plan that minimizes the total cost may be selected or otherwise determined.

In some implementations, the motion planning system 205 may be configured to iteratively update the route or route extension for the vehicle 180 as new sensor data is obtained from one or more sensors 201. For example, as new sensor data is obtained from one or more sensors 201, the sensor data may be analyzed by the perception system 203, the prediction system 204, and the motion planning system 205 to determine the motion plan.

The motion planning system 205 may provide control commands to one or more vehicle controls 207. For example, the one or more vehicle controls 207 may include throttle systems, brake systems, steering systems, and other control systems, each of which may include various vehicle controls (e.g., actuators or other devices that control gas flow, steering, braking) to control the motion of the vehicle 180. The various vehicle controls 207 may include one or more controllers, control devices, motors, and/or processors.

The vehicle controls 207 includes a brake control module 220. The brake control module 220 is configured to receive a braking command and bring about a response by applying (or not applying) the vehicle brakes. In some examples, the brake control module 220 includes a primary system and a secondary system. The primary system receives braking commands and, in response, brakes the vehicle 180. The secondary system may be configured to determine a failure of the primary system to brake the vehicle 180 in response to receiving the braking command.

A steering control system 232 is configured to receive a steering command and bring about a response in the steering mechanism of the vehicle 180. The steering command is provided to a steering system to provide a steering input to steer the vehicle 180.

A lighting/auxiliary control module 236 receives a lighting or auxiliary command. In response, the lighting/auxiliary control module 236 controls a lighting and/or auxiliary system of the vehicle 180. Controlling a lighting system may include, for example, turning on, turning off, or otherwise modulating turn signals, headlights, parking lights, running lights, etc. Controlling an auxiliary system may include, for example, modulating windshield wipers, a defroster, etc.

A throttle control system 234 is configured to receive a throttle command and bring about a response in the engine speed or other throttle mechanism of the vehicle. For example, the throttle control system 234 may instruct an engine and/or engine controller, or other propulsion system component to control the engine or other propulsion system of the vehicle 180 to accelerate, decelerate, or remain at its current speed.

Each of the perception system 203, the prediction system 204, the motion planning system 205, the commander system 211, the navigator system 213, and the localizer system 230, may be included in or otherwise be a part of a vehicle autonomy system 202 configured to control the vehicle 180 based at least in part on data obtained from one or more sensors 201. For example, data obtained by one or more sensors 201 may be analyzed by each of the perception system 203, the prediction system 204, and the motion planning system 205 in a consecutive fashion in order to control the vehicle 180.

In sample embodiments, the vehicle 180 may further include an AV display 250 that displays routes, route segments, and instructions to the driver. For example, the instructions may instruct the driver to exit the vehicle 180 at the next driver transfer location. An AV switching module 260 may also be provided to switch the vehicle 180 into and out of autonomy mode. This switching may be automatic or may be performed manually by the human driver in sample embodiments.

Also, in sample embodiments, the vehicle 180 may also include driver sensors 270 (e.g., seat sensors or sensors inside or outside the vehicle 180) that detect the presence and removal of the human driver from the vehicle 180, as well as authenticate the human driver prior to the beginning of the manual portion of the trip. Also, the vehicle 180 may have a stopped vehicle detection system 280 that does not allow the human driver to exit the vehicle 180 unless the vehicle 180 is completely stopped and the parking brake is engaged. Also, for rider convenience, the ride app 175 and/or audio/visual displays 250 within the vehicle 180 may notify the rider that the human driver is about to exit the vehicle 180 or that a human driver is about to enter the vehicle 180. The rider may also be provided with a photograph, name, etc. of the human driver that will be entering the vehicle so that the rider may verify that the driver is the correct driver.

While FIG. 2 depicts elements suitable for use in a vehicle autonomy system according to example aspects of the present disclosure, one of ordinary skill in the art will recognize that other vehicle autonomy systems may be configured to control an autonomous vehicle based on sensor data.

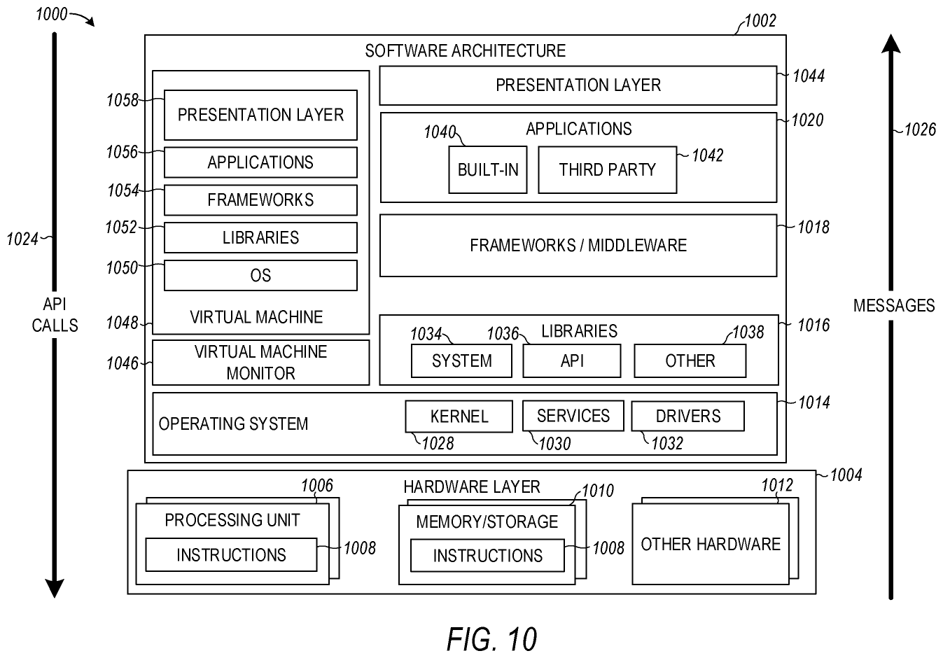

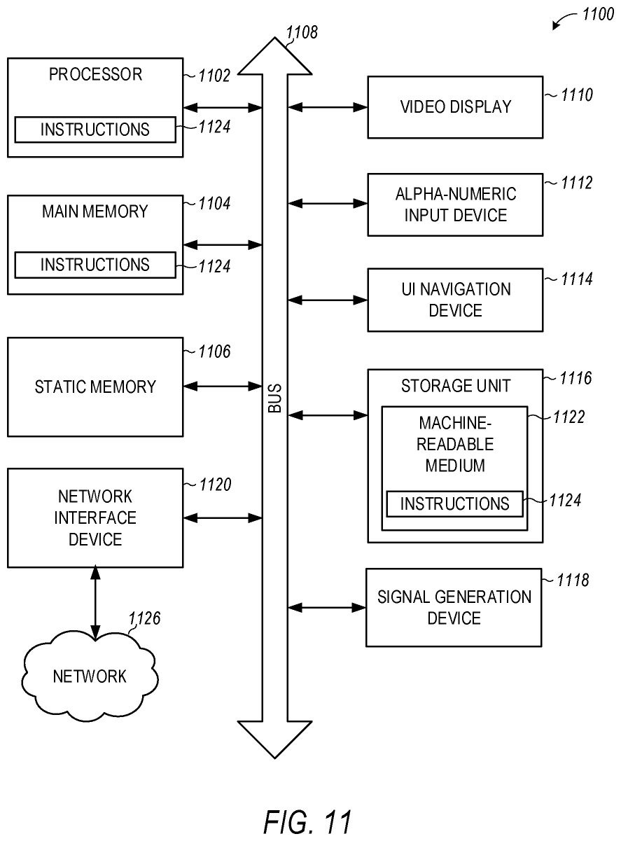

The vehicle autonomy system 202 includes one or more computing devices, which may implement all or parts of the perception system 203, the prediction system 204, the motion planning system 205 and/or the localizer system 230. Descriptions of hardware and software configurations for computing devices to implement the hybrid vehicle autonomy system 202 are provided herein at FIGS. 10 and 11.

In various examples, when the AV 180 is selected to service a transport request, the planning system 100 may transmit transport instructions to the commander system 211 over one or more networks. As described herein, the transport instructions may include routing instructions for the human driver to manually operate the AV 180 in areas appropriate for a human driver. Specifically, the transport instructions may be processed by the vehicle autonomy system 202 to generate, on the AV display screen 250 of the AV 180, a route that provides the human driver with route instructions from the pick-up location to the destination and/or a driver transfer location where the human driver will exit the vehicle. The AV 180 is then switched to autonomy mode to continue the trip on the route segments appropriate for driving in the autonomous mode. The transport instructions may also include autonomy route planning information that the vehicle autonomy system 202 may process to generate an updated route plan for the vehicle control module 207 once the AV 180 is within the portion of the route appropriate for autonomous driving and may utilize the routing graphs. Accordingly, the transport instructions 122 may provide the vehicle autonomy system 202 with an overall route at least from a given pick-up location to a drop-off location for a requesting user. The transport instructions 122 may also provide route data from the current location of the AV 180 to the pick-up location. In sample embodiments, the routing may take into account weather forecasts, sensors inputs, time of day, construction activity, accidents, etc. when calculating the optimal route.

The route may be displayed on the AV display 250 as live route data enabling the human driver to manually drive the AV 180 to the pick-up location to rendezvous with a requesting user, and from the pick-up location to the destination. When the AV 180 reaches one or more route segment that is more appropriate for robot driving and the requesting user has accepted autonomous driving (and optionally the one or more route segments are at least predetermined percentage of the overall route to justify switching to autonomous mode), the display 250 of the AV 180 may provide an indication to the human driver to exit the vehicle and to switch the AV 180 into autonomy mode. The human driver may do so by providing input to an AV switching module 260, which may comprise one or more switches, buttons, display features, and the like. The input on the AV switching module 260 may indicate a mode selection to the vehicle autonomy system 202, which may cause the vehicle autonomy system 202 to take control of the vehicle's control mechanisms 207. Alternative, the AV 180 may automatically switch into autonomy mode based on sensor inputs when the driver leaves the AV 180.

Thereafter, the vehicle autonomy system 202 may execute the route plan that takes the AV 180 from a driver transfer location where the driver exits to the destination or to a subsequent route segment that is more suitable for human driving. At the subsequent route segment, the AV 180 would stop at a driver transfer location to pick-up a human driver to continue driving over the subsequent route segment. In such a case, the AV 180 is instructed to pull into the driver transfer location adjacent or within the subsequent route segment to pick-up a human driver to complete the trip over the remaining portions of the route that are appropriate for a human driver. Upon entering the vehicle, the human driver may provide another input to the autonomy switching module 260 to generate a mode selection instructing the vehicle autonomy system 202 to no longer provide autonomous control of the control mechanisms 207. As such, the AV display 250, executing transport instructions, may display the most optimal route to the drop off location. The human driver may follow this live route while manually operating the AV 180 to drop off the requesting user at the drop off location.

Examples described herein recognize that the pick-up location or the drop-off location may be located within a region suitable for autonomous driving and that no human driver may be needed for completion of a transport request. Also, the human driver may on occasion stray from the route, which may trigger a certain action by the trip planning system 100. For example, the trip planning system 100 may continue monitoring the location data of the AV 180. If the location data indicates that the AV 180 has strayed from the route, the trip planning system 100 may be triggered to update the route.

In certain examples, if the route is updated, the trip planning system 100 may determine that a new or alternative route is more optimal than the original. Accordingly, the human driver's divergence from the route may trigger updates to the overall trip for the requesting user. Accordingly, a divergence from the route or the human driver's independent selection of a new route may trigger the trip planning system 100 to recalculate or optimize an updated route, which may change the route segments and, accordingly, change the number and use of different driver transfer locations on the updated route.

Certain functions of the trip planning system 100 described herein may be performed on-board by the vehicle autonomy system 202. For example, the transport instructions may simply include a pick-up location and a drop-off location for a requesting user, and the vehicle autonomy system 202 may perform the route optimizations described herein. Furthermore, in determining the most optimal routes, the vehicle autonomy system may utilize stored route graphs, a road network map, a live traffic map, and/or localization maps, and may utilize the same to perform a number of route optimizations for the overall trip. In addition, the vehicle autonomy system 202 may monitor route progress when the AV 180 is in manual mode and generate a user interface for the human driver on the AV display 250 indicating the driver transfer locations along the route and provide driver prompts to indicate to the driver when to exit the AV 180 and to switch the AV 180 to autonomy mode.

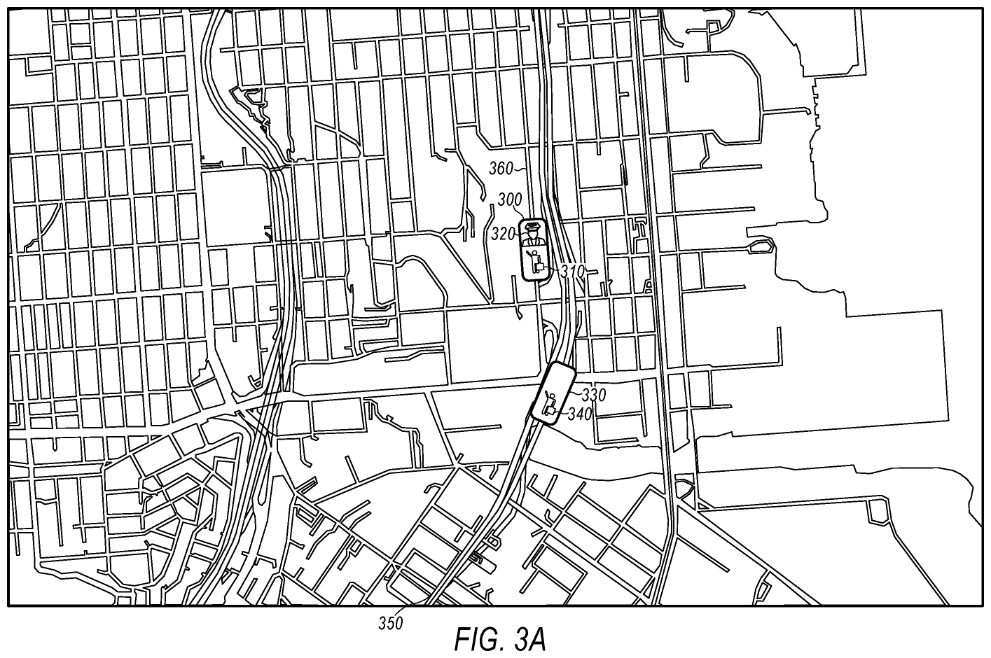

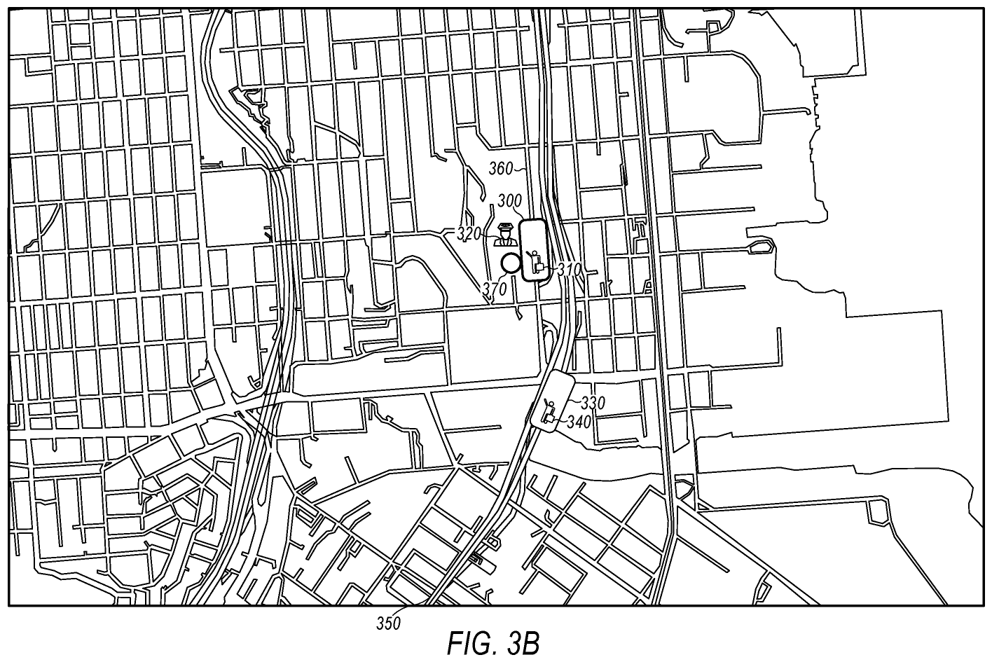

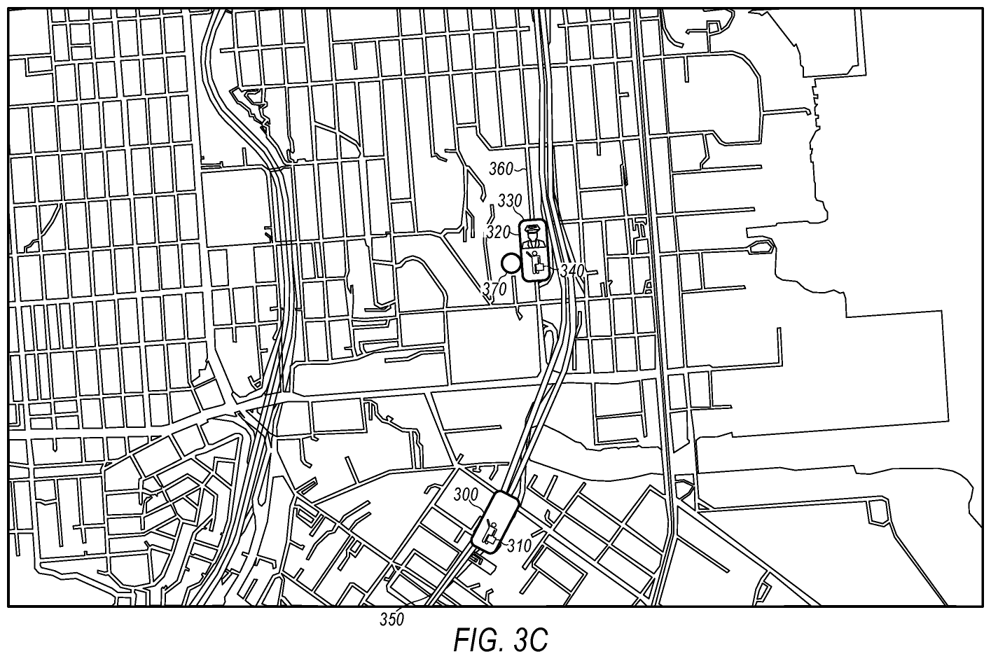

FIGS. 3A-3C collectively illustrate a driver drop-off and pick-up in a sample embodiment. FIG. 3A illustrates a first AV 300 that is driving a first payload (e.g., rider) 310 to the destination requested by the first rider in the first rider's transport request 171. In this example, the first AV 300 is being driven by a human driver 320 over route segments 360 that are not appropriate for a robot driver. Also, a second AV 330 in autonomy mode (i.e., no human driver) is driving a second payload (e.g., rider) 340 over a route segment 350 that is appropriate for autonomous driving (in this case, a highway segment).

As illustrated in FIG. 3B, the human driver 320 stops the first vehicle 300 at the driver transfer location 370, which is also an entry point to the highway and to the route segment 350 that is appropriate for autonomous driving. The human driver exits the first AV 300 at the driver transfer location 370. As indicated, the second AV 330 has now driven further along the route segment 350 towards the exit point of the highway adjacent the driver transfer location 370.

FIG. 3C illustrates the first AV 300 after dropping off the human driver 320 at the driver transfer location 370. The first AV 300 has entered autonomy mode and entered the route segment 350 suitable for autonomous driving (i.e., the highway segment) with rider 310 but without the human driver 320. Also, the second AV 330 has now stopped at the driver transfer location 370 adjacent the exit point of the highway to pick-up the human driver 320. The human driver 320 switches the second AV 330 into manual mode (or the AV 330 switches into manual mode automatically) and continues the trip to the destination requested by the second rider 340 in the second rider's transport request 171. It will be appreciated that the first AV 300 may further stop at another driver transfer location at the destination end of the route segment 350 to pick-up another human driver to complete the trip in the manual mode to the destination requested by the first rider 310 of the first AV 300.

FIGS. 4A-4D illustrate sample driver transfer locations in sample embodiments. For example, FIG. 4A illustrates a driver transfer location 400 that is simply a public street interchange point that is, for example, a safe pull off location on the side of a public street. The pull off location may or may not include appropriate lane markings or designated stopping zones. In this example, the driver transfer location 400 is not necessarily at an entry or exit point of a highway as in the example of FIGS. 3A-3C.

FIG. 4B illustrates a driver transfer location 410 that is a dedicated interchange point. For example, the driver transfer location 410 may be a dedicated portion of a parking lot.

FIG. 4C illustrates a driver transfer location 420 that is a dedicated interchange point that is owned and/or operated by the operator 430 of the fleet of AVs or by a third-party fleet operator or third-party operator of interchange points or AVs.

Finally, FIG. 4D illustrates a driver transfer location 440 that is a dedicated interchange point located in a median strip of a highway or major artery and that is owned and/or operated by the operator of the fleet of AVs or by a third-party fleet operator or third-party operator of interchange points or AVs. It will be appreciated that in this example the AVs 460 may approach the driver transfer location from opposite ends of an island 450. In this example, the human driver may need to enter or exit the AV 460 from either side of the island 450 and potentially from either side of the AV 460. In sample embodiments, a driver pod 470 also may be provided to give the driver a place to wait until the next AV 460 to be driven by the human driver arrives. The driver pod 470 may be situated to enable quick access to the approaching AV 460. Sensors 480 (e.g., cameras) may also be provided to detect the presence/removal of the human driver from an AV 460.

In each of the driver transfer locations illustrated in FIGS. 4A-4D, one or more high throughput lanes may be provided with optional “pods” that provide a place for the human drivers to wait in between rides. Also, if high constraints are required, the driver transfer locations may be provided on the motorway with over/under passes to tunnel the drivers to/from the driver transfer locations. Also, the driver transfer locations may be located in the “middle divider” of the highway to avoid tunnels, etc. and to use existing spare land.

As another example, “natural” stopping areas may be leveraged for use as a driver transfer location. For instance, if there is a row of consecutive lighted intersections near the edge of the in-scope areas for autonomy, there is a high likelihood that the vehicle needs to stop anyway for one of the consecutive lights and that the stopping time may be used to make a driver handoff. For example, if there are ten consecutive lighted intersections and based on data it is known that a vehicle driving at or under the speed limit will deterministically stop for at least one of the ten intersections, the vehicle may not even need a dedicated pickup/drop-off zone to perform a driver swap.

In certain scenarios, a driver transfer may potentially be performed while moving. In this scenario, multiple SDVs may drive the same speed in parallel and allow drivers and/or riders to move between the vehicles. Safety could be enhanced by having the vehicles physically merge to form a completely closed space.

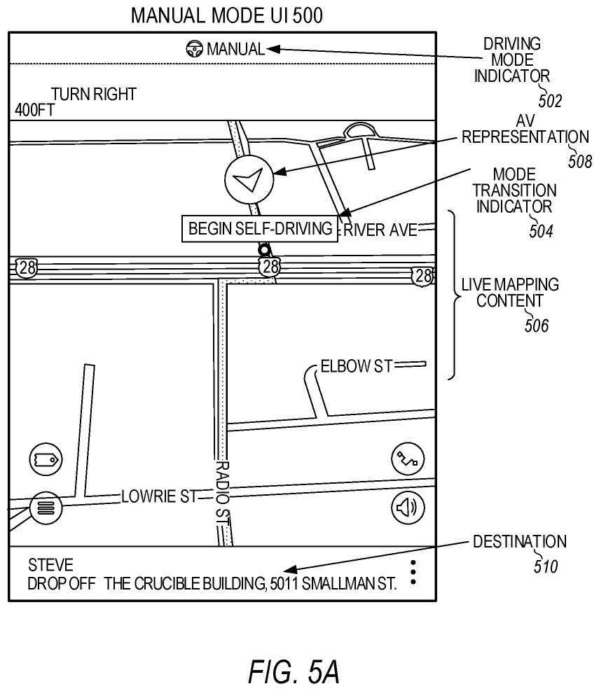

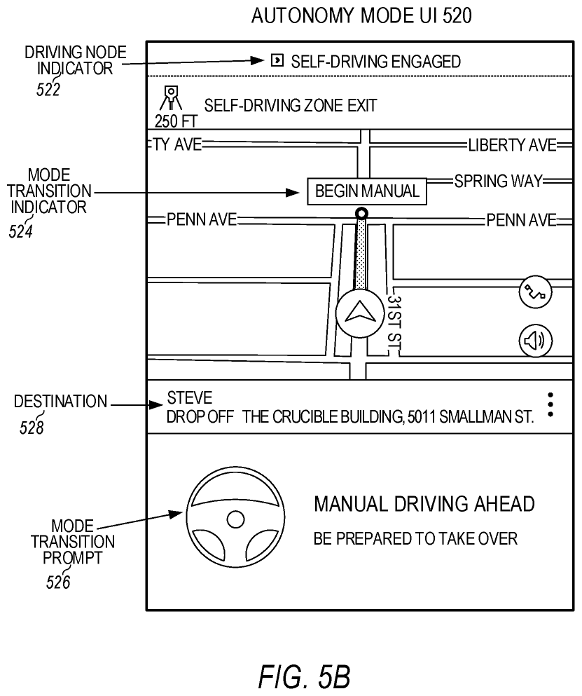

FIGS. 5A and 5B depict example user interfaces providing mode transition prompts for a human driver of an AV 180. The respective user interfaces may be generated on the display screen within the interior cabin of the AV (e.g., AV display 250 shown in FIG. 2), such as on the dashboard, a head-up display area, a computing device of the driver (e.g., a smartphone or tablet computer), or the center console of the AV 180. As illustrated in FIG. 5A, the display screen 250 may generate a manual mode user interface 500 when the human driver is in control of the AV 180. For example, the manual driving mode of the AV180 may be indicated by a driving mode indicator 502 on the manual mode user interface 500. In the example shown in FIG. 5A, the human driver has picked-up a rider and is manually driving the AV 180 along a route including a route segment suitable for autonomous driving. The driver transfer location is indicated by the mode transition indicator 504. The mode transition indicator 504 signifies a precise location at which the human driver is to pull into a driver transfer location, exit the AV 180, and switch the AV 180 from manual driving mode to autonomous or self-driving mode. Alternatively, the AV 180 may automatically switch into autonomous driving mode when the human driver exits the AV 180.

The manual mode user interface 500 may further display live mapping content 506 that provides real-time directions along the route to the driver transfer location. The manual mode interface 500 may further include an AV representation 508 indicating the current location of the AV as the human driver operates the AV 180 towards the driver transfer location. Once the AV arrives at the mode transition indicator 504, the human driver pulls into the driver transfer location, exits the AV, and switches the AV 180 to full autonomous mode, enabling the vehicle autonomy system 202 of the AV 180 to take over vehicle operations. Accordingly, the AV 180 may autonomously drive through its autonomous route segment towards the destination 510.

As illustrated in FIG. 5B, the autonomy mode user interface 520 may be displayed when the AV 180 is operating in autonomous or self-driving mode. Accordingly, the driving mode indicator 522 may indicate that the AV 180 is currently operating in self-driving mode along a route segment towards the next route segment that is more suitable for human driving, signified by the mode transition indicator 524. The mode transition indicator 524 of FIG. 5B may indicate the location at which the AV 180 is to pull into a driver transfer location to pick-up a human driver who switches the AV 180 back to manual drive mode. When the AV 180 reaches within a predetermined distance or time from the mode transition location represented by the mode transition indicator 524, the autonomy mode user interface 520 may prominently display a mode transition prompt 526 and/or audibilize a message to notify a rider that the AV 180 will be picking-up a human driver. Once the AV 180 arrives at the driver transfer location, the human driver may switch the AV 180 back to manual drive mode upon entering the AV 180 and then manually operate the AV 180 along the indicated route to the destination 528.

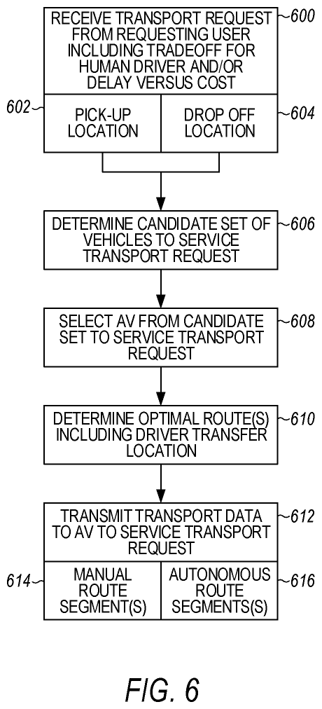

FIG. 6 is a flow chart describing an example method of hybrid trip planning for autonomous vehicles, according to examples described herein. In the discussion of FIG. 6, reference may be made to characters representing like features as shown and described with respect to FIGS. 1 and 2. Furthermore, the steps and processes described with respect to FIG. 6 may be performed by an example trip planning system 100 as shown and described with respect to FIG. 1. As illustrated in FIG. 6, the trip planning system 100 may receive the transport request 171 from a requesting user/rider 174 (600). In various implementations, the transport request 171 may include a pick-up location (602) and a drop off location (604), as well as a user/rider preference for minimizing time or cost of the trip (e.g., where the user/rider chooses a slower ride involving a robot-driven portion to reduce the cost or chooses the fastest ride involving a human driver only at a higher cost). Based on the transport request 171, the trip planning system 100 may determine a candidate set of vehicles to service transport request 171 (606). This candidate set of vehicles may comprise only AVs, only human driven vehicles, or a combination of AVs and human driven vehicles, depending on the user/rider preference for minimizing time or cost of the transport request, as well as the human versus robot driving combination chosen for the given transport request by the Selection Engine 130. However, in accordance with the embodiments described herein, it is assumed that an AV 180 with or without a human driver is selected for servicing the service transport request 171.

The trip planning system 100 may then select an AV 189 from the candidate set to service the transport request 171 (608). Based on the pick-up location, drop-off location, and user/rider preference for minimizing time or cost of the trip, the trip planning system 100 may determine optimal route(s), with consideration given to driver transfer locations (610). As will be described further below, selection of the optimal routes at 610 may further take into account the expected wait time for the human driver to wait at the driver transfer location for another AV to arrive to be driven by the human driver. Trip planning system 100 may then transmit transport instructions 122 to the selected AV 189 to enable a combination of the AV with human driver and AV with robot driver under control of the vehicle autonomy system 202 to execute an overall route plan in order to service the transport request 171 (612). Transport instructions 122 may be divided between manual route segments (614) and autonomous route segments (616) as described herein.

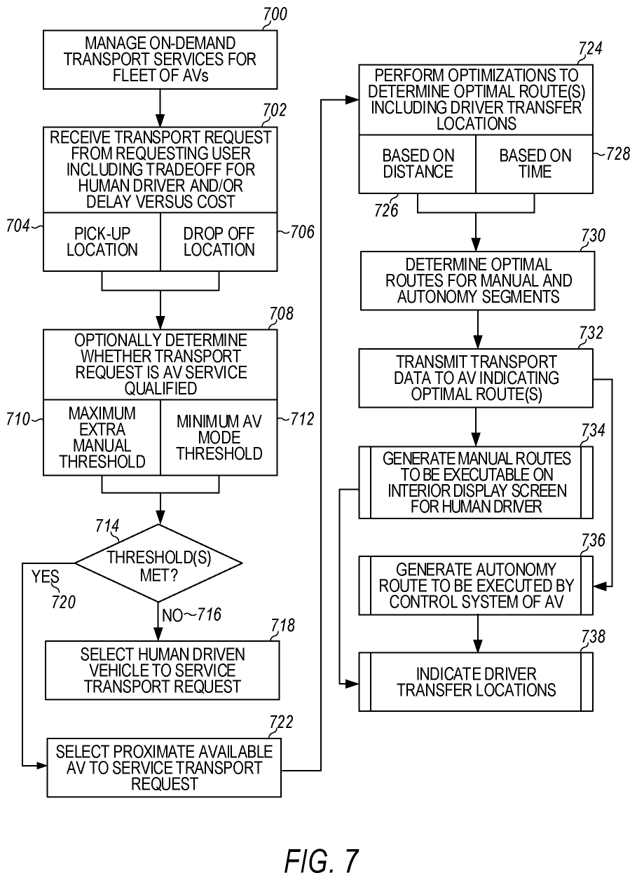

FIG. 7 is a flow chart describing a lower level example of a method of hybrid trip planning for autonomous vehicles, according to examples described herein. In the description of FIG. 7, reference may also be made to reference characters representing like features as shown and described with respect to FIGS. 1 and 2. Furthermore, the processes described with respect to FIG. 7 may also be performed by an example trip planning system 100 as shown and described with respect to FIG. 1. In FIG. 7, trip planning system 100 may manage on-demand transport services for a fleet of AVs 180 (700) that may also include vehicles that are not equipped with self-driving systems. In doing so, trip planning system 100 may receive transport requests 171 from requesting users 174 (702). Each transport request 171 may include a pick-up location (704) and a drop-off location (706), as well as a user/rider preference for minimizing time or cost of the trip.

The trip planning system 100 optionally may determine whether the transport request 171 is AV service qualified or whether the transport request 171 satisfies a set of criteria corresponding to AV transport services (708). For example, trip planning system 100 may determine whether the overall trip corresponding to the transport request 171 does not exceed a maximum extra manual driving threshold (710) (i.e., not too much human driving). Additionally, or alternatively, the trip planning system 100 may determine whether the overall trip corresponding to the transport request meets a minimum AV mode threshold (712) (i.e., enough autonomy mode driving is possible to make human driver exit at a driver transfer location worthwhile). Thus, trip planning system 100 may determine whether the thresholds are met (714). If not (716), of if the user/rider preference has indicated a preference for minimizing the time of the transport request, then the trip planning system 100 may select a human driven vehicle (e.g., a closest available vehicle) to service the transport request 171 (718). However, if the thresholds are met (720), and if the user/rider preference has indicated a preference for minimizing the cost of the transport request or no preference, the trip planning system 100 may select a proximate available AV with or without a human driver to service the transport request 171 (722).

It is contemplated that the set of criteria corresponding to AV transport services may act as a filter for the transport requests 171. As such, if the criteria are met, then the trip planning system 100 may either select only from a group of candidate AVs or select from a blend of human driven vehicles and AVs. In either case, trip planning system 100 may select a most optimal vehicle (e.g., a closest vehicle in terms of distance or time). For example, the trip planning system 100 may select a closest vehicle using a road network map, or a vehicle having a shortest ETA to the pick-up location using a live traffic map.

In various examples, the trip planning system 100 may perform optimizations to determine the most optimal route taking into account any mode transitions at driver transfer locations along the calculated route (724). These most optimal routes may be determined based on distance (726) or time (728) or some other consideration. In variations, the most optimal route may be determined based on an overall route optimization between the pick-up location and drop-off location, as described herein. In other variations, the most optimal routes are determined based on the availability of a co-located driver transfer location. In still further variations, the optimization also accounts for the time of arrival at the driver transfer locations by respective AVs that would minimize the driver's wait to drive another AV after being dropped off. In yet other variations, the optimization may minimize the rider's delay or maintain the rider's delay within a rider-selected range. For example, the rider or the requestor that requested delivery of a package may agree to a slight delay for a reduction in the cost of the ride. It will be appreciated that the availability of a human driver is provided as another input to the optimization calculations in these scenarios.

The trip planning system 100 may further determine optimal routes for the route segments appropriate for manual driving and autonomy driving (730). Trip planning system 100 may then generate and transmit transport instructions 122 to the AV 189 that indicates the optimal route(s) (732). Accordingly, the transport instructions 122 may include manual routes along route segments appropriate for manual (human) driving as well as autonomy routes along route segments appropriate for robot driving.

In generating the transport instructions 122, the trip planning system 100 may generate the manual routes to be executable on an interior display screen of the AV 189 for the human driver (734). The trip planning system 100 may also generate the autonomy route to be executed by the vehicle autonomy system 202 of the AV 189 (736). Still further, the transport instructions 122 may further provide prompts for the human driver indicating the drop-off points at the driver transfer locations (738).

As described herein, one or more steps described with respect to the flow charts of FIGS. 6 and 7 may be performed by the vehicle autonomy system 202 of the AV 180. For example, the vehicle autonomy system 202 may perform optimizations to determine the most optimal routes for both the manual and autonomy route segments of the trip (730). However, it will be appreciated that information from other AVs would be needed by the Selection Engine 130 to perform this optimization.

Alternatively, a human or robot driven AV may pick up/drop off other human drivers along a route while executing a specific trip from driver transfer locations (or random locations) in order to manage the supply/demand of human drivers in various regions. For example, the human driver may be dropped off at a random location (not a driver transfer location) if the driver may be picked up by a second robot-driven AV soon after to complete the second leg of the second car's trip which requires a human driver.

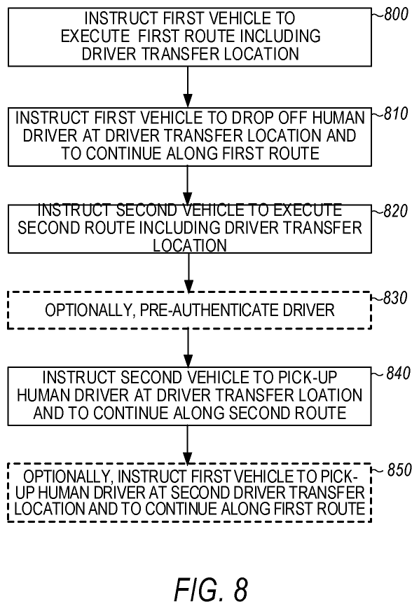

FIG. 8 is a flow chart of a method for routing two autonomous vehicles that share one human driver in sample embodiments. In the example of FIG. 8, a system is described that routes vehicles by instructing a first vehicle having a human driver to execute a first route for delivering a first payload from a first pick-up location to a first destination where the first route includes a driver transfer location (800). The first vehicle is further instructed to drop-off the human driver at the driver transfer location and to continue along the first route without the human driver (810). The system further instructs a second vehicle to execute a second route that also includes the driver transfer location (820), which may occur as the first vehicle is heading to the transfer location in order to minimize rider wait time. After optionally pre-authenticating the human driver (830), the second vehicle is further instructed to pick-up the human driver from the first vehicle at the driver transfer location and to continue along the second route with the human driver (840). As a further option, the first vehicle may be instructed to pick-up a second human driver at a second driver transfer location along the first route and to continue along the first route with the second human driver toward the first destination to deliver the first payload (850). Depending upon the route and the associated timing for the route segments, such driver entries/exits may occur multiple times along the route.

In sample embodiments, the route segments of the first route after the driver transfer location are labeled as suitable for autonomous driving so that the first vehicle may continue along the first route in autonomous driving mode. Similarly, the route segments of the second route after the driver transfer location are labeled as unsuitable for autonomous driving, and the driving over such route segments are handled by the human driver. As noted above, the vehicles may be controlled by different transportation services that do not recognize the route graphs of the other transportation service and thus proceed in manual (human) driving mode over the unrecognized route segments. In this example, the vehicles for the respective services may operate in autonomy mode on routing graphs for their respective transport services but not for the other transport services.

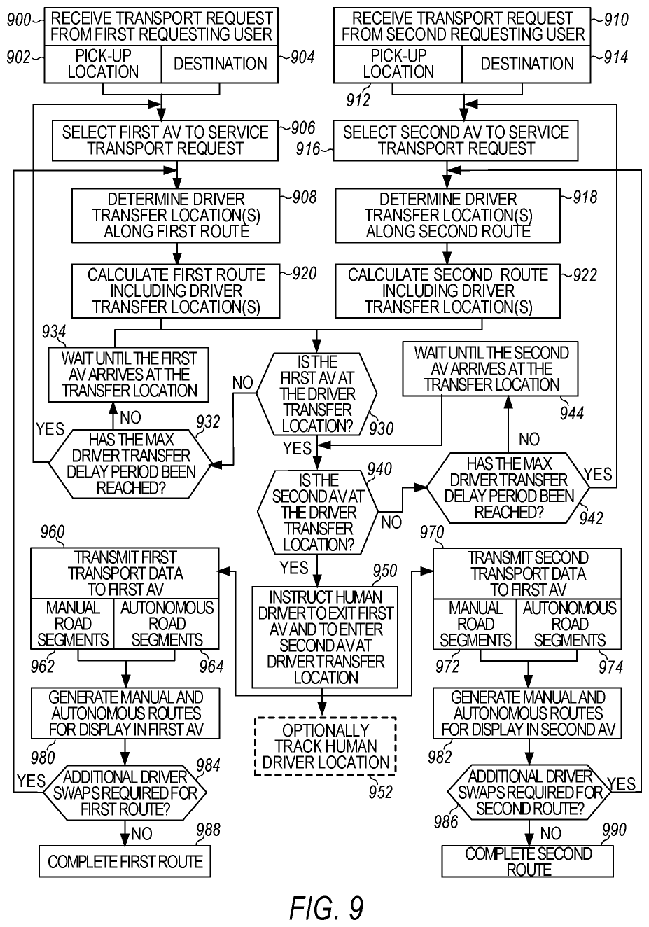

FIG. 9 illustrates a flow chart of a method for routing first and second autonomous vehicles (AVs) to share a human driver for at least portions of respective trips by the first and second autonomous vehicles. The method is implemented by one or more processors of the trip planning system 100 (FIG. 1) and includes receiving a first transport request from a first requesting user (900). The first transport request includes a request to transport the first requesting user from a first pick-up location (902) to a first destination (904) specified by the first requesting user. Similarly, a second transport request is received from a second requesting user (910). The second transport request includes a request to transport the second requesting user from the second pick-up location (912) to a second destination (914) specified by the second requesting user. Upon receipt of the first and second transport requests, the trip planning system 100 determines the first pick-up location (902) and the first destination (904) for the first requesting user from the first transport request (900) and the second pick-up location (912) and the second destination (914) for the second requesting user from the second transport request (910). The trip planning system 100 selects the first AV to service the first transport request (906) and selects the second AV to service the second transport request (916). For hybrid routes to be completed using autonomous and manual driving modes selected pursuant to methods described above with respect to FIGS. 7 and 8, a driver transfer location is determined for the first AV (908) and for the second AV (918) that provides access to route segments on which the first AV and second AV may operate in autonomous mode. A first route between the first pick-up location 902 and the first destination 904 for the first AV is calculated (920) that includes the driver transfer location adjacent the route segments suitable for autonomy mode driving. Similarly, a second route between the second pick-up location 912 and the second destination 914 for the second AV is calculated (922) that includes the driver transfer location adjacent the route segments suitable for autonomy mode driving.

The trip planning system 100 further determines whether the first AV and the second AV arrive at the same driver transfer location at approximately the same time. As used herein, at “approximately the same time” means within an acceptable delay period based on system attributes relating to acceptable wait times for riders and/or human drivers or attributes provided by one or both of the requesting users relating to the amount of acceptable delay in reaching the respective destinations and/or acceptable driver wait time at the driver transfer location. This delay is referred to as the maximum driver transfer delay period that is acceptable for routing the first AV and the second AV through the same driver transfer location so that a human driver of the first AV may transfer to the second AV. The trip planning system 100 checks whether the first AV is at the driver transfer location (930) and, if not, checks whether the maximum driver transfer delay period has been reached (932). If so, and the first AV has not arrived at the driver transfer location, the first AV is selected to service a new transport request (906). Otherwise, the trip planning system 100 waits until the first AV arrives at the driver transfer location (934). Once the first AV arrives at the driver transfer location (930), the trip planning system 100 determines whether the second AV has arrived at the driver transfer location (940). If not, the trip planning system 100 checks whether the maximum driver transfer delay period has been reached (942). If so, and the second AV has not arrived at the driver transfer location, the second AV is selected to service a new transport request (916). Otherwise, the trip planning system 100 waits until the second AV arrives at the driver transfer location (944).

Once both the first AV and the second AV have arrived at the driver transfer location, the human driver in the first AV is instructed to exit the first AV at the driver transfer location and to enter the second AV upon arrival at the driver transfer location (950). Optionally, the hybrid transfer system may track the location of the human driver (952) as a separate entity within the routing system so that the location of the driver at any given time may be tracked in the same manner that vehicles are tracked. This tracking permits improved matching of the human driver to vehicles and also minimizes the waiting time for the human driver. Such tracking also permits the driver to be returned to a specified driver transfer location at the end of a shift as well as other logistics of transportation of the human driver between driver transfer locations.

In sample embodiments, the human driver is tracked in the same manner as the respective vehicles. For example, the human driver may be tracked by GPS data from the human driver's mobile phone or via any reliable method of ensuring the presence of the driver in both vehicles and the driver transfer location throughout the course of the transfer request. In addition, the drivers could use wearable devices equipped with GPS or other sensor capabilities. The wearables could also be used to track biometric data and infer stress levels, fatigue, etc. Also, if the tracking need not be performed continuously, then the drivers may also use RFID technology for tapping in and out of the transfer location or use a Bluetooth emitting device and a receptor located at the transfer location to achieve the same results.

Also, the vehicles may be designed to include the necessary tools for doing remote work by the human drivers. In scenarios in which the human driver of the vehicle stays in the vehicle in areas in which the vehicle is operating in autonomy, that driver time may be used to do some remote work for the fleet operator (e.g., being a remote concierge or remote QA for the rest of the fleet).

Whether or not the human driver has been instructed to switch from the first AV to the second AV at the driver transfer location, the first transport data is transmitted to the first AV (960). When the human driver has been instructed to switch from the first AV to the second AV at the driver transfer location, the first transport data provides the calculated first route to the human driver to continue driving the first AV in a manual driving mode from the pick-up location to the driver transfer location along manual route segments (962). Also, when in autonomous driving mode, the first transport data provides vehicle routing data to enable automated driving of the first AV over the first route segments suitable for autonomous driving (964). Similarly, second transport data is transmitted to the second AV (970). When the human driver has been instructed to switch from the second AV at the driver transfer location, the second transport data provides the calculated second route to the human driver to continue to drive the second AV in a manual driving mode from the driver transfer location to the drop-off location or to the second destination along manual route segments (972). Also, when in autonomous driving mode, the second transport data provides second route segments to the second AV to enable automated driving of the second AV over the second route segments suitable for autonomous driving (974).

The first AV and the second AV proceed along their routes and receive manual and/or autonomous route information for display on their respective audio/visual display systems (980, 982). The displayed information may instruct the human driver to enter/exit the respective AV at a driver transfer location along the respective routes as appropriate to complete the respective routes. For example, upon exiting an autonomous driving mode at a driver transfer location, a human driver at the driver transfer location (or soon to arrive at the driver transfer location) may be instructed to take over driving of the first AV or the second AV upon arrival at the driver transfer location. The instructions may include a notification to a first audio/visual display of the first AV to notify the first requesting user that the human driver is about to exit the first AV and/or a notification to a second audio/visual display of the second AV to notify the second requesting user that the human driver is about to enter the second AV.

When it is determined that additional driver swaps are required to complete the first route (984) or the second route (986), then the additional driver transfer locations along the first route (908) and along the second route (918) are determined. When no additional driver swaps are required to complete the respective routes, the first route is completed (988) and the second route is completed (990).

The routing optimizations of the respective AVs including the driver transfer locations are performed to minimize the wait time of the respective riders in the first AV, the second AV and/or the wait time of the human driver at the driver transfer location, and/or to provide an optimal allocation of resources (e.g. maximize vehicle utilization) which could lead to non-optimal wait times. It will be appreciated that the human driver may be reassigned to a different vehicle as a result of traffic delays and the like. Once assigned to a vehicle, the human driver enters the vehicle into manual mode and completes the route. On the other hand, if the human driver is instructed to exit the first AV or the second AV at the driver transfer location, the vehicle may enter the autonomous mode and complete the route. Also, under certain circumstances (e.g., end of human driver shift or illness of the human driver), human drivers may be swapped at the driver transfer location.

It will be further appreciated that completing the routes (988, 990) may further include determining a second driver transfer location that provides access to the route segments suitable for autonomous driving by the first AV and the second AV. In this case, the first route between the first pick-up location and the first destination and/or the second route between the second pick-up location and the second destination may include the driver transfer location, the common route segments suitable for autonomous driving, and the second driver transfer location. In such a case, the transport data transmitted to the respective AVs is provided to a second human driver picked-up at the second driver transfer location to enable the second human driver to drive the AV in a manual driving mode from the second driver transfer location to the specified destination.

In sample embodiments, selecting the first AV to service the first transport request (906) and/or the second AV to service the second transport request (916) is based on the first and second pick-up locations and the first and second destinations identified in the first and second transport requests fulfilling a set of criteria including the maximum driver transfer delay period that the second AV will wait for the human driver to arrive at the driver transfer location, exit the first AV, and enter the second AV. In such embodiments, determining the driver transfer location may take into account supply/demand and likelihood or distribution of delay versus time for the human driver, the first requesting user, and the second requesting user. Also, determining the driver transfer location (908, 918) may further take into account an expected arrival time of the human driver at the driver transfer location and an expected arrival time of the second AV at the driver transfer location to minimize a wait time of the human driver.

In further sample embodiments, calculating the first route and the second route (920, 922) may include evaluating preferences from the first requesting user between time and cost for a trip from the first pick-up location to the first destination and preferences from the second requesting user between time and cost for a trip from the second pick-up location to the second destination. The preferences may include whether the first and second requesting users would prefer to spend more to arrive in less time with only the human driver or spend less to arrive in more time where at least part of the trip from the first pick-up location to the first destination or from the second pick-up location to the second destination is driven in autonomous mode without a human driver.

It will be appreciated that the optimizations described above with respect to FIG. 7-9 for determining a most optimal route may further take into account system load balancing, supply/demand, and likelihood or distribution of delay versus time for the human driver and the respective riders. For example, the route optimization may take as inputs additional data describing the likelihood that the rider may reach the target destination with an acceptably small chance (e.g., <1%) that that rider will be delayed more than an acceptable delay (e.g., >2 min) as a result of the driver exit at the driver transfer location and switch to autonomy mode. Further optimizations take into account the arrival time of the human driver at a driver transfer location and the expected arrival time of the next AV at the driver transfer location to minimize the wait time of the human driver.

In other sample embodiments, settings in the rider app 175 further allow the rider and/or the user requesting delivery of a package or other payload to select their preference between time and cost. For example, would the rider prefer to spend $50 to arrive in 30 minutes (100% human driven) or $30 to arrive in 35 minutes (25% human driven, 75% robot driven). Alternatively, the rider app 175 may enable the rider and/or the user requesting delivery of a package or other payload to enable/disable self-driving as an option for part of the routes.

It will be further appreciated that providing a system to enable a human driver to switch between multiple AVs introduces additional timing, safety, and logistical considerations. To address such concerns, techniques may be provided to speed up the swapping in/out of human drivers to minimize interruptions to the rider's ride. For example, an authentication system for the human driver may be provided so that the human driver is ready and waiting when the AV arrives. Also, to minimize delay in starting the manual drive when the human driver enters the AV, the human driver's cabin preferences, including seat, steering wheel position, and/or mirror adjustments may be entered as stored driver settings into the AV so that the driver's seat, steering wheel position, and/or mirrors are pre-adjusted when the driver enters the vehicle. Such driver settings data may be provided as part of the pre-authentication process. Still further, the AV may receive stored driver settings that include identification information that authenticate the human driver when the human driver approaches the AV so that the driver's door automatically unlocks based on proximity of the AV to the human driver at the driver transfer location. A number of technologies such as RFID, BlueTooth™, etc. may be used to share the identification information between the AV and the human driver. To provide additional security, off-the shelf solutions and products may be used for identification using facial recognition, iris scanning, fingerprinting technologies, biometrics, voice recognition, and other driver authentication technologies. Such technologies may be provided on the AV and/or at the driver transfer locations for verification of the human driver and/or the rider before the human driver is permitted to take over control of the AV. Such technologies are well-known to those skilled in the art and will not be elaborated upon herein.

To further facilitate fast exits/entrances of human drivers at the driver transfer locations, the pods 470 and infrastructure at the transfer locations may be designed so that the human driver is ready and waiting next to the driver side car door when the AV arrives at the driver transfer location (e.g., so that the human driver may safely enter the AV and drive away safely within say 10 seconds).

Also, the AV may include storage space so that the human driver may store alternate modes of transportation (e.g., a scooter with a charger stored in the AV storage space) to facilitate travel to/from one driver transfer location to another driver transfer location and between the human driver's home and a driver transfer location where the human driver starts/ends the human driver's work day. Also, the transportation of the human driver to/from home and a driver transfer location and/or between driver transfer locations may be factored into the routing data for the driver via the driver application 186.

It will be appreciated that the system described herein does not require the human driver to own a vehicle. The human driver may be paid an hourly wage that is independent from the number of trips driven. Conversely, the human driver may be paid by trip with the number of trips maximized through the optimized driver transfers at the driver transfer locations. Also, the drivers may stay in dedicated driver zones and develop familiarity with those driver zones. For example, the driver zone for a human driver may be near the human driver's home or other familiar location. Additionally, the human driver may be picked up by the robot-driven AV at the human driver's home at the beginning of his/her shift.

The system described herein further facilitates the development of controlled driver transfer locations for AVs without drivers at busy locations such as at airports. Also, the AV may be driven to the driver transfer location by one human driver and driven away by another human driver when the human driver departs the AV at the driver transfer location.

It will be further appreciated that the system described herein enables the downtime for the AV to approach zero.

The hybrid approach described herein also solves the problem of disconnected islands of autonomy grid maps by enabling a human driver to connect routes between respective autonomy grid maps.

The system described herein provides new ways to match vehicles, drivers and riders to minimize driver downtime, maximize ride safety for riders, maximize use of transportation operator's assets, and thereby maximize profit for the transportation operator. The system described herein also improves flexibility afforded by having different types of vehicles providing different services. For example, the delivery time of certain items may not be as sensitive as the completion of rideshare trips with paying customers. In those cases, the driver transfer locations could also be used to store vehicles carrying cargo that needs to be delivered with less urgency, whose manual route portions could be completed during periods of low rideshare demand. Also, the rider's convenience may always be a key weighting in the optimization problems as time is generally a key constraint to any routing optimization, and those weightings may be adjusted based on rider inputs to trade off time with cost/convenience. For example, the rider may choose to wait longer for a lower price point. The rider may also elect whether to accept a robot driver as well as how many driver switches are acceptable.

Also, by collecting data during the human driver operated portions of the route, additional autonomy routes may be enabled more rapidly to expand the areas on the autonomy grid maps.

One or more aspects described herein provide that methods, techniques and actions performed by a computing device are performed programmatically or as a computer-implemented method. Programmatically means through the use of code or computer-executable instructions. A programmatically performed step may or may not be automatic.

One or more aspects described herein may be implemented using programmatic modules or components. A programmatic module or component may include a program, a subroutine, a portion of a program, a software component, or a hardware component capable of performing one or more stated tasks or functions. In addition, a module or component may exist on a hardware component independently of other modules or components. Alternatively, a module or component may be a shared element or process of other modules, programs, or machines.

Furthermore, one or more aspects described herein may be implemented through the use of instructions that are executable by one or more processors. These instructions may be carried on a computer-readable medium. Machines shown or described with figures below provide examples of processing resources and computer-readable media on which instructions for implementing some aspects may be carried and/or executed. In particular, the numerous machines shown in some examples include processor(s) and various forms of memory for holding data and instructions. Examples of computer-readable media include permanent memory storage devices, such as hard drives on personal computers or servers. Other examples of computer storage media include portable storage units, such as CD or DVD units, flash or solid-state memory (such as carried on many cell phones and consumer electronic devices), and magnetic memory. Computers, terminals, network-enabled devices (e.g., mobile devices such as cell phones) are all examples of machines and devices that utilize processors, memory, and instructions stored on computer-readable media.

Alternatively, one or more examples described herein may be implemented through the use of dedicated hardware logic circuits that are comprised of an interconnection of logic gates. Such circuits are typically designed using a hardware description language (HDL), such as Verilog or VHDL. These languages contain instructions that ultimately define the layout of the circuit. However, once the circuit is fabricated, there are no instructions, and the processing is performed by interconnected gates.

FIG. 10 is a block diagram 1000 showing one example of a software architecture 1002 for a computing device. The software architecture 1002 may be used in conjunction with various hardware architectures, for example, as described herein. FIG. 10 is merely a non-limiting example of a software architecture 1002 and many other architectures may be implemented to facilitate the functionality described herein. A representative hardware layer 1004 is illustrated and may represent, for example, any of the above-referenced computing devices. In some examples, the hardware layer 1004 may be implemented according to an architecture 1100 of FIG. 11 and/or the software architecture 1002 of FIG. 10.

The representative hardware layer 1004 comprises one or more processing units 1006 having associated executable instructions 1008. The executable instructions 1008 represent the executable instructions of the software architecture 1002, including implementation of the methods, modules, components, and so forth of FIGS. 1-2 and FIGS. 6-9. The hardware layer 1004 also includes memory and/or storage modules 1010, which also have the executable instructions 1008. The hardware layer 1004 may also comprise other hardware 1012, which represents any other hardware of the hardware layer 1004, such as the other hardware illustrated as part of the architecture 1100.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware 1018, applications 1020, and a presentation layer 1044. Operationally, the applications 1020 and/or other components within the layers may invoke application program interface (API) calls 1024 through the software stack and receive a response, returned values, and so forth illustrated as messages 1026 in response to the API calls 1024. The layers illustrated are representative in nature and not all software architectures have all layers. For example, some mobile or special-purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of a hardware or software interrupt and, in response, cause the software architecture 1002 to pause its current processing and execute an interrupt service routine (ISR) when an interrupt is received. The ISR may generate an alert.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1016 may provide a common infrastructure that may be used by the applications 1020 and/or other components and/or layers. The libraries 1016 typically provide functionality that allows other software modules to perform tasks in an easier fashion than by interfacing directly with the underlying operating system 1014 functionality (e.g., kernel 1028, services 1030, and/or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be used by the applications 1020 and/or other software components/modules. For example, the frameworks 1018 may provide various graphical user interface (GUI) functions, high-level resource management, high-level location services, and so forth. The frameworks 1018 may provide a broad spectrum of other APIs that may be used by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a contacts application, a browser application, a book reader application, a location application, a media application, a messaging application, and/or a game application. The third-party applications 1042 may include any of the built-in applications 1040 as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™ Windows® Phone, or other computing device operating systems. In this example, the third-party application 1042 may invoke the API calls 1024 provided by the mobile operating system such as the operating system 1014 to facilitate functionality described herein.

The applications 1020 may use built-in operating system functions (e.g., kernel 1028, services 1030, and/or drivers 1032), libraries (e.g., system libraries 1034, API libraries 1036, and other libraries 1038), or frameworks/middleware 1018 to create user interfaces to interact with users of the system. Alternatively, or additionally, in some systems, interactions with a user may occur through a presentation layer, such as the presentation layer 1044. In these systems, the application/module “logic” may be separated from the aspects of the application/module that interact with a user.

Some software architectures use virtual machines. For example, systems described herein may be executed using one or more virtual machines executed at one or more server computing machines. In the example of FIG. 10, this is illustrated by a virtual machine 1048. A virtual machine creates a software environment where applications/modules may execute as if they were executing on a hardware computing device. The virtual machine 1048 is hosted by a host operating system (e.g., the operating system 1014) and typically, although not always, has a virtual machine monitor 1046, which manages the operation of the virtual machine 1048 as well as the interface with the host operating system (e.g., the operating system 1014). A software architecture executes within the virtual machine 1048, such as an operating system 1050, libraries 1052, frameworks/middleware 1054, applications 1056, and/or a presentation layer 1058. These layers of software architecture executing within the virtual machine 1048 may be the same as corresponding layers previously described or may be different.

FIG. 11 is a block diagram illustrating a computing device hardware architecture 1100, within which a set or sequence of instructions may be executed to cause a machine to perform examples of any one of the methodologies discussed herein. The hardware architecture 1100 describes a computing device for executing the vehicle autonomy system, described herein.

The architecture 1100 may operate as a standalone device or may be connected (e.g., networked) to other machines. In a networked deployment, the architecture 1100 may operate in the capacity of either a server or a client machine in server-client network environments, or it may act as a peer machine in peer-to-peer (or distributed) network environments. The architecture 1100 may be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 1100 includes a processor unit 1102 comprising at least one processor (e.g., a central processing unit (CPU), a graphics processing unit (GPU), or both, processor cores, compute nodes). The architecture 1100 may further comprise a main memory 1104 and a static memory 1106, which communicate with each other via a link 1108 (e.g., bus). The architecture 1100 may further include a video display unit 1110, an input device 1112 (e.g., a keyboard), and a UI navigation device 1114 (e.g., a mouse). In some examples, the video display unit 1110, input device 1112, and UI navigation device 1114 are incorporated into a touchscreen display. The architecture 1100 may additionally include a storage device 1116 (e.g., a drive unit), a signal generation device 1118 (e.g., a speaker), a network interface device 1120, and one or more sensors (not shown), such as a Global Positioning System (GPS) sensor, compass, accelerometer, or other sensor.

In some examples, the processor unit 1102 or another suitable hardware component may support a hardware interrupt. In response to a hardware interrupt, the processor unit 1102 may pause its processing and execute an ISR, for example, as described herein.

The storage device 1116 includes a non-transitory machine-readable medium 1122 on which is stored one or more sets of data structures and instructions 1124 (e.g., software) embodying or used by any one or more of the methodologies or functions described herein. The instructions 1124 may also reside, completely or at least partially, within the main memory 1104, within the static memory 1106, and/or within the processor unit 1102 during execution thereof by the architecture 1100, with the main memory 1104, the static memory 1106, and the processor unit 1102 also constituting machine-readable media.

The various memories (i.e., 1104, 1106, and/or memory of the processor unit(s) 1102) and/or storage device 1116 may store one or more sets of instructions and data structures (e.g., instructions) 1124 embodying or used by any one or more of the methodologies or functions described herein. These instructions, when executed by processor unit(s) 1102 cause various operations to implement the disclosed examples.

As used herein, the terms “machine-storage medium,” “device-storage medium,” “computer-storage medium” (referred to collectively as “machine-storage medium 1122”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 1122 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 1122 specifically exclude carrier waves, modulated data signals, and other such media, at least some of which are covered under the term “signal medium” discussed below.

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 1124 may further be transmitted or received over a communications network 1126 using a transmission medium via the network interface device 1120 using any one of a number of well-known transfer protocols (e.g., HTTP). Examples of communication networks include a LAN, a WAN, the Internet, mobile telephone networks, plain old telephone service (POTS) networks, and wireless data networks (e.g., Wi-Fi, 3G, 4G LTE/LTE-A, 5G or WiMAX networks). The term “transmission medium” shall be taken to include any intangible medium that is capable of storing, encoding, or carrying instructions for execution by the machine, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

### EXAMPLES

Certain embodiments are described herein as numbered examples 1, 2, 3, etc. These numbered examples are provided as examples only and do not limit the subject technology.

Example 1 is a system that routes vehicles, comprising one or more processors and one or more memories storing instructions that, when executed by the one or more processors, cause the one or more processors to: instruct a first vehicle having a human driver to execute a first route for delivering a first payload from a first pick-up location to a first destination, the first route including a driver transfer location, wherein instructing the first vehicle includes providing an instruction to the first vehicle to drop-off the human driver at the driver transfer location and to continue along the first route autonomously; and instruct a second vehicle that is operating autonomously to execute a second route that also includes the driver transfer location, wherein instructing the second vehicle includes providing an instruction to the second vehicle to pick-up the human driver from the first vehicle at the driver transfer location and to continue along the second route with the human driver operating the second vehicle manually.

Example 2 is a system as in Example 1, wherein route segments of the first route after the driver transfer location are labeled as suitable for autonomous driving.

Example 3 is a system as in Examples 1-2, wherein route segments of the second route after the driver transfer location are labeled as unsuitable for autonomous driving.

Example 4 is a system as in Examples 1-3, wherein the first vehicle executes the first route for a first transportation service and the second vehicle executes the second route for a second transportation service.

Example 5 is a system as in Examples 1-4, wherein the executed instructions further cause the one or more processors to instruct the first vehicle to cause first mapping and routing information to be generated on an interior user interface of the first vehicle, the first mapping and routing information providing the human driver with an optimal route from the first pick-up location to the driver transfer location.

Example 6 is a system as in Examples 1-5, wherein the executed instructions further cause the one or more processors to instruct the second vehicle to cause second mapping and routing information to be generated on an interior user interface of the second vehicle, the second mapping and routing information providing the human driver with an optimal route from the driver transfer location to a destination of the second route.

Example 7 is a system as in Examples 1-6, wherein the first route comprises a second driver transfer location, the executed instructions further causing the one or more processors to instruct the first vehicle to pick-up a second human driver at the second driver transfer location and to continue along the first route with the second human driver toward the first destination to deliver the first payload.

Example 8 is a system as in Examples 1-7, wherein the executed instructions cause the one or more processors to determine the first route including the driver transfer location and the second driver transfer location based on distance optimizations using a road network map.

Example 9 is a system as in Examples 1-8, wherein the executed instructions cause the one or more processors to determine the first route including the driver transfer location and the second driver transfer location based on time optimizations using a live traffic map.

Example 10 is a system as in Examples 1-9, wherein the executed instructions further cause the one or more processors to perform an optimization to determine an autonomy route for the first vehicle along route segments from the driver transfer location to the second driver transfer location and to transmit route data to the first vehicle, the route data being executable by a control system of the first vehicle to indicate an optimized autonomy route from the driver transfer location to the second driver transfer location.

Example 11 is a system as in Examples 1-10, wherein the executed instructions further cause the one or more processors to receive a first transport request for delivering the first payload from the first pick-up location to the first destination and to select the first vehicle to service the first transport request based on the first pick-up location and the first destination identified in the first transport request fulfilling a set of criteria including at least one of a distance threshold, a time threshold, and a driver wait time threshold.

Example 12 is a system as in Examples 1-11, wherein the distance threshold comprises a minimum distance percentage in which the first vehicle may be in an autonomous mode between the first pick-up location and the first destination or a maximum distance percentage in which the first vehicle may be in a manual mode between the first pick-up location and the first destination.

Example 13 is a system as in Examples 1-12, wherein the time threshold comprises an autonomy time threshold comprising a minimum time percentage in which the first vehicle may be in the autonomous mode between the first pick-up location and the first destination or a manual time threshold comprising a maximum time percentage in which the first vehicle may be in a manual mode between the first pick-up location and the first destination.

Example 14 is a system as in Examples 1-13, wherein the driver wait time threshold comprises a maximum time that the second vehicle will wait for the human driver to arrive at the driver transfer location via the first vehicle, exit the first vehicle, and enter the second vehicle.

Example 15 is a system as in Examples 1-14, wherein the first transport request includes preferences from a first requesting user between minimizing at least one of time and cost for a trip from the first pick-up location to the first destination, the preferences including whether the first requesting user would prefer to spend more to arrive in less time with only the human driver or spend less to arrive in more time where at least part of the trip from the first pick-up location to the first destination is driven in autonomous mode without a human driver.

Example 16 is a system as in Examples 1-15, wherein the driver transfer location comprises a pull off location on a side of a public street adjacent a route segment that is suitable for autonomous driving.

Example 17 is a system as in Examples 1-16, wherein the driver transfer location comprises a dedicated interchange point adjacent a route segment that is suitable for autonomous driving.

Example 18 is a system as in Examples 1-17, wherein the driver transfer location comprises a dedicated interchange point located in a median strip or on a side of a roadway of a route segment that is suitable for autonomous driving.

Example 19 is a system as in Examples 1-18, further comprising a pod at the driver transfer location that provides a place for the human driver to wait after exiting the first vehicle until arrival of the second vehicle.

Example 20 is a system as in Examples 1-19, wherein the executed instructions further cause the one or more processors to determine the first route and the second route by taking into account supply/demand and likelihood or distribution of delay versus time for the human driver and the first payload.

Example 21 is a system as in Examples 1-20, wherein the executed instructions further cause the one or more processors to determine the first route and the second route by taking into account an expected arrival time of the human driver at the driver transfer location and an expected arrival time of the second vehicle at the driver transfer location to minimize a wait time of the human driver.

Example 22 is a system as in Examples 1-21, further comprising an authentication system for pre-authenticating the human driver to drive the second vehicle before the human driver is enabled to enter the second vehicle.

Example 23 is a system as in Examples 1-22, wherein the authentication system further provides the human driver's cabin preferences including at least one of seat, steering wheel, and mirror adjustments to the second vehicle so that the cabin preferences of the second vehicle may be pre-adjusted when the human driver enters the second vehicle.

Example 24 is a system as in Examples 1-23, wherein the authentication system provides identification information to the second vehicle that authenticates the human driver when the human driver approaches the second vehicle so that a door of the second vehicle automatically unlocks based on proximity of the second vehicle to the human driver at the driver transfer location.

Example 25 is a system as in Examples 1-24, wherein the authentication system comprises at least one of an RFID system and a BlueTooth™ system that communicates the identification information between the human driver and the second vehicle.

Example 26 is a system as in Examples 1-25, wherein the authentication system comprises at least one of a facial recognition system, an iris scanning system, a fingerprinting system, and a voice recognition system.

Example 27 is a system as in Examples 1-26, wherein at least one of the first vehicle, the second vehicle, and the driver transfer location comprises sensors that detect the presence or exiting of the human driver from the first vehicle or the presence or entrance of the human driver into the second vehicle.

Example 28 is a system as in Examples 1-27, wherein the first vehicle comprises a stopped vehicle detection system that prohibits the human driver from exiting the first vehicle unless the first vehicle is completely stopped and a parking brake is engaged.

Example 29 is a system as in Examples 1-28, wherein the first vehicle comprises a first audio/visual display that notifies a user that the human driver is about to exit the first vehicle and the second vehicle comprises a second audio/visual display that notifies the user that the human driver is about to enter the second vehicle.

Example 30 is a system as in Examples 1-29, wherein the executed instructions further cause the one or more processors to determine transportation of the human driver between driver transfer locations.

Example 31 is a computer-implemented method of routing vehicles, the method being performed by one or more processors and comprising: instructing a first vehicle having a human driver to execute a first route for delivering a first payload from a first pick-up location to a first destination, the first route including a driver transfer location, wherein instructing the first vehicle includes providing an instruction to the first vehicle to drop-off the human driver at the driver transfer location and to continue along the first route autonomously; and instructing a second vehicle that is operating autonomously to execute a second route that also includes the driver transfer location, wherein instructing the second vehicle includes providing an instruction to the second vehicle to pick-up the human driver from the first vehicle at the driver transfer location and to continue along the second route with the human driver operating the second vehicle manually.

Example 32 is a method as in Example 31, further comprising labeling route segments of the first route after the driver transfer location as suitable for autonomous driving.

Example 33 is a method as in Examples 31-32, further comprising labeling route segments of the second route after the driver transfer location as unsuitable for autonomous driving.

Example 34 is a method as in Examples 31-33, wherein the first vehicle executes the first route for a first transportation service and the second vehicle executes the second route for a second transportation service.

Example 35 is a method as in Examples 31-34, wherein the first route comprises a second driver transfer location, further including instructing the first vehicle to pick-up a second human driver at the second driver transfer location and to continue along the first route with the second human driver toward the first destination to deliver the first payload.

Example 36 is a method as in Examples 31-35, further comprising determining the first route including the driver transfer location and the second driver transfer location based on distance optimizations using a road network map.

Example 37 is a method as in Examples 31-36, further comprising determining the first route including the driver transfer location and the second driver transfer location based on time optimizations using a live traffic map.

Example 38 is a method as in Examples 31-37, further comprising performing an optimization to determine an autonomy route for the first vehicle along route segments from the driver transfer location to the second driver transfer location and to transmit route data to the first vehicle, the route data being executable by a control system of the first vehicle to indicate an optimized autonomy route from the driver transfer location to the second driver transfer location.

Example 39 is a method as in Examples 31-38, further comprising receiving a first transport request for delivering the first payload from the first pick-up location to the first destination and selecting the first vehicle to service the first transport request based on the first pick-up location and the first destination identified in the first transport request fulfilling a set of criteria including at least one of a distance threshold, a time threshold, and a driver wait time threshold.

Example 40 is a method as in Examples 31-39, wherein the distance threshold comprises a minimum distance percentage in which the first vehicle may be in an autonomous mode between the first pick-up location and the first destination or a maximum distance percentage in which the first vehicle may be in a manual mode between the first pick-up location and the first destination.

Example 41 is a method as in Examples 31-40, wherein the time threshold comprises an autonomy time threshold comprising a minimum time percentage in which the first vehicle may be in the autonomous mode between the first pick-up location and the first destination or a manual time threshold comprising a maximum time percentage in which the first vehicle may be in a manual mode between the first pick-up location and the first destination.

Example 42 is a method as in Examples 31-41, wherein the driver wait time threshold comprises a maximum time that the second vehicle will wait for the human driver to arrive at the driver transfer location via the first vehicle, exit the first vehicle, and enter the second vehicle.

Example 43 is a method as in Examples 31-42, wherein the first transport request includes preferences from a first requesting user between minimizing at least one of time and cost for a trip from the first pick-up location to the first destination, the preferences including whether the first requesting user would prefer to spend more to arrive in less time with only the human driver or spend less to arrive in more time where at least part of the trip from the first pick-up location to the first destination is driven in autonomous mode without a human driver.

Example 44 is a method as in Examples 31-43, further comprising determining the first route and the second route by taking into account supply/demand and likelihood or distribution of delay versus time for the human driver and the first payload.

Example 45 is a method as in Examples 31-44, further comprising determining the first route and the second route by taking into account an expected arrival time of the human driver at the driver transfer location and an expected arrival time of the second vehicle at the driver transfer location to minimize a wait time of the human driver.

Example 46 is a method as in Examples 31-45, further comprising pre-authenticating the human driver to drive the second vehicle before the human driver is enabled to enter the second vehicle.

Example 47 is a method as in Examples 31-46, further comprising providing the human driver's cabin preferences including at least one of seat, steering wheel, and mirror adjustments to the second vehicle so that the driver's cabin preferences for the second vehicle may be pre-adjusted when the human driver enters the second vehicle.

Example 48 is a method as in Examples 31-47, further comprising providing identification information to the second vehicle that authenticates the human driver when the human driver approaches the second vehicle so that a door of the second vehicle automatically unlocks based on proximity of the second vehicle to the human driver at the driver transfer location.

Example 49 is a method as in Examples 31-48, further comprising providing instructions to a first audio/visual display of the first vehicle that notifies a user that the human driver is about to exit the first vehicle and providing instructions to a second audio/visual display of the second vehicle that notifies the user that the human driver is about to enter the second vehicle.

Example 50 is a method as in Examples 31-49, further comprising determining transportation of the human driver between driver transfer locations.

Example 51 is a non-transitory computer-readable medium storing instructions that, when executed by one or more processors, cause the one or more processors to route vehicles, comprising instructing a first vehicle having a human driver to execute a first route for delivering a first payload from a first pick-up location to a first destination, the first route including a driver transfer location, wherein instructing the first vehicle includes providing an instruction to the first vehicle to drop-off the human driver at the driver transfer location and to continue along the first route autonomously; and instructing a second vehicle that is operating autonomously to execute a second route that also includes the driver transfer location, wherein instructing the second vehicle includes providing an instruction to the second vehicle to pick-up the human driver from the first vehicle at the driver transfer location and to continue along the second route with the human driver operating the second vehicle manually.

Example 52 is a medium as in Example 51, wherein the first route comprises a second driver transfer location, further comprising instructions that when executed instruct the first vehicle to pick-up a second human driver at the second driver transfer location and to continue along the first route with the second human driver toward the first destination to deliver the first payload.

Example 53 is a medium as in Examples 51-52, further comprising instructions that when executed perform an optimization to determine an autonomy route for the first vehicle along route segments from the driver transfer location to the second driver transfer location and transmit route data to the first vehicle, the route data being executable by a control system of the first vehicle to indicate an optimized autonomy route from the driver transfer location to the second driver transfer location.

Example 54 is a medium as in Examples 51-53, further comprising instructions that when executed receive a first transport request for delivering the first payload from the first pick-up location to the first destination and select the first vehicle to service the first transport request based on the first pick-up location and the first destination identified in the first transport request fulfilling a set of criteria including at least one of a distance threshold, a time threshold, and a driver wait time threshold.

Example 55 is a medium as in Examples 51-54, wherein the distance threshold comprises a minimum distance percentage in which the first vehicle may be in an autonomous mode between the first pick-up location and the first destination or a maximum distance percentage in which the first vehicle may be in a manual mode between the first pick-up location and the first destination.

Example 56 is a medium as in Examples 51-55, wherein the time threshold includes an autonomy time threshold comprising a minimum time percentage in which the first vehicle may be in the autonomous mode between the first pick-up location and the first destination or a manual time threshold comprising a maximum time percentage in which the first vehicle may be in a manual mode between the first pick-up location and the first destination.

Example 57 is a medium as in Examples 51-56, wherein the driver wait time threshold comprises a maximum time that the second vehicle will wait for the human driver to arrive at the driver transfer location via the first vehicle, exit the first vehicle, and enter the second vehicle.

Example 58 is a medium as in Examples 51-57, wherein the first transport request includes preferences from a first requesting user between minimizing at least one of time and cost for a trip from the first pick-up location to the first destination, the preferences including whether the first requesting user would prefer to spend more to arrive in less time with only the human driver or spend less to arrive in more time where at least part of the trip from the first pick-up location to the first destination is driven in autonomous mode without a human driver.

Example 59 is a medium as in Examples 51-58, further comprising instructions that when executed determine the first route and the second route by taking into account supply/demand and likelihood or distribution of delay versus time for the human driver and the first payload.

Example 60 is a medium as in Examples 51-59, further comprising instructions that when executed determine the first route and the second route by taking into account an expected arrival time of the human driver at the driver transfer location and an expected arrival time of the second vehicle at the driver transfer location to minimize a wait time of the human driver.

Example 61 is a medium as in Examples 51-60, further comprising instructions that when executed pre-authenticate the human driver to drive the second vehicle before the human driver is enabled to enter the second vehicle.

Example 62 is a medium as in Examples 51-61, further comprising instructions that when executed provide the human driver's cabin preferences including at least one of seat, steering wheel, and mirror adjustments to the second vehicle so that the driver's cabin preferences for the second vehicle may be pre-adjusted when the human driver enters the second vehicle.

Example 63 is a medium as in Examples 51-62, further comprising instructions that when executed provide identification information to the second vehicle that authenticates the human driver when the human driver approaches the second vehicle so that a door of the second vehicle automatically unlocks based on proximity of the second vehicle to the human driver at the driver transfer location.

Example 64 is a medium as in Examples 51-63, further comprising instructions that when executed provide instructions to a first audio/visual display of the first vehicle that notifies a user that the human driver is about to exit the first vehicle and provide instructions to a second audio/visual display of the second vehicle that notifies the user that the human driver is about to enter the second vehicle.

Example 65 is a medium as in Examples 51-64, further comprising instructions that when executed determine transportation of the human driver between driver transfer locations.

The above description is intended to be illustrative, and not restrictive. For example, the above-described examples (or one or more aspects thereof) may be used in combination with others. Other examples may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features may be grouped together to streamline the disclosure. However, the claims not set forth every feature disclosed herein, as examples may feature a subset of such features. Further, examples may include fewer features than those disclosed in a particular example. Thus, the following claims are hereby incorporated into the Detailed Description, with each claim standing on its own as a separate example. The scope of the examples disclosed herein is to be determined with reference to the appended claims, along with the full scope of equivalents to which such claims are entitled.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example may be combined with other individually described features, or parts of other examples, even if the other features and examples make no mention of the particular feature. Thus, the absence of describing combinations should not preclude claiming rights to such combinations.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

1. A system that routes vehicles, comprising:
one or more processors; and
one or more memories storing instructions that, when executed by the one or more processors, cause the one or more processors to:
instruct a first vehicle having a human driver to execute a first route for delivering a first payload from a first pick-up location to a first destination, the first route including a driver transfer location, wherein instructing the first vehicle includes providing an instruction to the first vehicle to drop-off the human driver at the driver transfer location and to continue along the first route autonomously; and
instruct a second vehicle that is operating autonomously to execute a second route that also includes the driver transfer location, wherein instructing the second vehicle includes providing an instruction to the second vehicle to pick-up the human driver from the first vehicle at the driver transfer location and to continue along the second route with the human driver operating the second vehicle manually.

2. A system as in claim 1, wherein route segments of the first route after the driver transfer location are labeled as suitable for autonomous driving and route segments of the second route after the driver transfer location are labeled as unsuitable for autonomous driving.

3. A system as in claim 1, wherein the first vehicle executes the first route for a first transportation service and the second vehicle executes the second route for a second transportation service.

4. The system of claim 1, wherein the executed instructions further cause the one or more processors to instruct the first vehicle to cause first mapping and routing information to be generated on an interior user interface of the first vehicle, the first mapping and routing information providing the human driver with an optimal route from the first pick-up location to the driver transfer location and.

5. The system of claim 1, wherein the executed instructions further cause the one or more processors to instruct the second vehicle to cause second mapping and routing information to be generated on an interior user interface of the second vehicle, the second mapping and routing information providing the human driver with an optimal route from the driver transfer location to a destination of the second route.

6. The system of claim 1, wherein the first route comprises a second driver transfer location, the executed instructions further causing the one or more processors to instruct the first vehicle to pick-up a second human driver at the second driver transfer location and to continue along the first route with the second human driver toward the first destination to deliver the first payload.

7. The system of claim 6, wherein the executed instructions cause the one or more processors to determine the first route including the driver transfer location and the second driver transfer location based on distance optimizations using a road network map.

8. The system of claim 6, wherein the executed instructions cause the one or more processors to determine the first route including the driver transfer location and the second driver transfer location based on time optimizations using a live traffic map.

9. The system of claim 6, wherein the executed instructions further cause the one or more processors to perform an optimization to determine an autonomy route for the first vehicle along route segments from the driver transfer location to the second driver transfer location and to transmit route data to the first vehicle, the route data being executable by a control system of the first vehicle to indicate an optimized autonomy route from the driver transfer location to the second driver transfer location.

10. The system of claim 1, wherein the executed instructions further cause the one or more processors to receive a first transport request for delivering the first payload from the first pick-up location to the first destination and to select the first vehicle to service the first transport request based on the first pick-up location and the first destination identified in the first transport request fulfilling a set of criteria including at least one of a distance threshold, a time threshold, and a driver wait time threshold comprising a maximum time that the second vehicle will wait for the human driver to arrive at the driver transfer location via the first vehicle, exit the first vehicle, and enter the second vehicle.

11. The system of claim 10, wherein the distance threshold comprises a minimum distance percentage in which the first vehicle may be in an autonomous mode between the first pick-up location and the first destination or a maximum distance percentage in which the first vehicle may be in a manual mode between the first pick-up location and the first destination.

12. The system of claim 10, wherein the time threshold comprises an autonomy time threshold comprising a minimum time percentage in which the first vehicle may be in the autonomous mode between the first pick-up location and the first destination or a manual time threshold comprising a maximum time percentage in which the first vehicle may be in a manual mode between the first pick-up location and the first destination.

13. The system of claim 10, wherein the first transport request includes preferences from a first requesting user between minimizing at least one of time and cost for a trip from the first pick-up location to the first destination, the preferences including whether the first requesting user would prefer to spend more to arrive in less time with only the human driver or spend less to arrive in more time where at least part of the trip from the first pick-up location to the first destination is driven in autonomous mode without a human driver.

14. The system of claim 1, wherein the driver transfer location comprises a pull off location on a side of a public street adjacent a route segment that is suitable for autonomous driving, a dedicated interchange point adjacent a route segment that is suitable for autonomous driving, or a dedicated interchange point located in a median strip or on a side of a roadway of a route segment that is suitable for autonomous driving.

15. The system of claim 1, wherein the executed instructions further cause the one or more processors to determine the first route and the second route by taking into account supply/demand and likelihood or distribution of delay versus time for the human driver and the first payload.

16. The system of claim 1, wherein the executed instructions further cause the one or more processors to determine the first route and the second route by taking into account an expected arrival time of the human driver at the driver transfer location and an expected arrival time of the second vehicle at the driver transfer location to minimize a wait time of the human driver.

17. A computer-implemented method of routing vehicles, the method being performed by one or more processors and comprising:
instructing a first vehicle having a human driver to execute a first route for delivering a first payload from a first pick-up location to a first destination, the first route including a driver transfer location, wherein instructing the first vehicle includes providing an instruction to the first vehicle to drop-off the human driver at the driver transfer location and to continue along the first route autonomously; and
instructing a second vehicle that is operating autonomously to execute a second route that also includes the driver transfer location, wherein instructing the second vehicle includes providing an instruction to the second vehicle to pick-up the human driver from the first vehicle at the driver transfer location and to continue along the second route with the human driver operating the second vehicle manually.

18. A method as in claim 17, further comprising receiving a first transport request for delivering the first payload from the first pick-up location to the first destination and selecting the first vehicle to service the first transport request based on the first pick-up location and the first destination identified in the first transport request fulfilling a set of criteria including at least one of a distance threshold, a time threshold, and a driver wait time threshold.

19. A non-transitory computer-readable medium storing instructions that, when executed by one or more processors, cause the one or more processors to route vehicles, comprising:
instructing a first vehicle having a human driver to execute a first route for delivering a first payload from a first pick-up location to a first destination, the first route including a driver transfer location, wherein instructing the first vehicle includes providing an instruction to the first vehicle to drop-off the human driver at the driver transfer location and to continue along the first route autonomously; and
instructing a second vehicle that is operating autonomously to execute a second route that also includes the driver transfer location, wherein instructing the second vehicle includes providing an instruction to the second vehicle to pick-up the human driver from the first vehicle at the driver transfer location and to continue along the second route with the human driver operating the second vehicle manually.

20. The medium of claim 51, wherein the first route comprises a second driver transfer location, further comprising instructions that when executed instruct the first vehicle to pick-up a second human driver at the second driver transfer location and to continue along the first route with the second human driver toward the first destination to deliver the first payload.
